(19) United States
(12) Patent Application Publication
(10) Pub. No.: US 2026/0346241 A1
(43) Pub. Date: Nov. 5, 2026

(54) SYSTEM FOR AUTOMATION OF CHEMICAL AND BIOLOGICAL ANALYTICAL PROCESSES

(71) Applicant: Next Labs, LLC, Rochester, NY (US)

(72) Inventor: Dennis M. Connolly, Rochester, NY (US)

(73) Assignee: Next Labs, LLC, Rochester, NY (US)

(21) Appl. No.: 19/120,734

(22) PCT Filed: Nov. 28, 2023
(86) PCT No.: PCT/US2023/081407

§ 371 Date: Apr. 11, 2025

Related U.S. Application Data
(60) Provisional application No. 63/380,137, filed on Oct. 19, 2022.
(60) Provisional application No. 63/480,050, filed on Jan. 16, 2023.
(60) Provisional application No. 63/480,056, filed on Jan. 16, 2023.
(60) Provisional application No. 63/443,235, filed on Feb. 3, 2023.

(51) Int. Cl. B01L 3/00; B01L 3/02

(52) U.S. Cl. CPC B01L 3/502; B01L 3/0217; B01L 3/527; B01L 2200/025; B01L 2200/026; B01L 2200/0647; B01L 2200/16; B01L 2300/042; B01L 2300/0809; B01L 2300/123; B01L 2400/0478; B01L 2400/0487

(57) ABSTRACT

The present invention provides a novel system consisting of a reader and a disposable cartridge to automate complex chemical and biological analytical processes. The system can automate many standard laboratory processes. The cartridge comprises a shuttle that moves along a rail in a housing. The shuttle moves linearly, step by step, through the process. The shuttle consists of reagent and reaction chambers. Syringes in the housing are fluidically connected to the chambers and are used to move fluids into and out of the chambers. The cartridge design is flexible to allow for a wide variety of complex processes to be automated. In particular, the present invention provides a system to automate all the steps needed to isolate and prepare nucleic acids for analysis.

### CROSS-REFERENCE TO RELATED APPLICATIONS

This is a US National Application of PCT/US 2023/081407, filed Nov. 28, 2023, and claims priority to U.S. Provisional Patent Applications Ser. No. 63/380,137, filed Oct. 19, 2022; Ser, No. 63/480,050, filed Jan. 16, 2023; Ser. No. 63/480,056, filed Jan, 16, 2023; and Ser. No. 63/443,235, filed Feb. 3, 2023, the contents of which are incorporated in their entirety by reference.

### TECHNOLOGICAL FIELD

The invention provides a system and methods for automating complex laboratory processes in a single disposable cartridge. In particular, the invention provides a system and method for automating the complex processes of nucleic acid isolation and preparation for nucleic acid sequencing.

### BACKGROUND OF THE INVENTION

Biological and chemical testing processes often are complex and require laboratory facilities and trained personnel. Many process steps increase the likelihood of human error and, thus, incorrect results. Complex processes have been automated with larger automated systems. However, there exists a need to automate processes in a deployable format that is easy and low-cost to use. In particular, analytical testing and biological analysis can benefit from a platform that can be readily reconfigured for different processes.

In general, chemical and biological testing use a variety of standard techniques: heating, mixing, disruption of samples, filtration, chromatography, separation, etc. Many disposable testing cartridges have been developed that carry out a limited number of process steps. There is a need for a simple system with a disposable cartridge that can be configured to carry out any of these common process steps in more complex testing protocols.

In the field of genomics, rapid and convenient nucleic acid-based testing can provide actionable results at the point of care. The need to send samples to core laboratories can result in treatment delays that can adversely impact patients. In remote and under-developed areas, health care is not readily available to residents in a timely and accessible manner. Inadequate access to health care facilities such as hospitals and clinics, or even health product/service retailers (e.g., drug stores), seriously hinders any effort to achieve timely diagnosis and treatment of patients, especially those suffering from an infectious disease, making it difficult to properly diagnose and treat those individuals. Despite many advances in technology over the past decades, there still exists a pressing need for new and improved diagnostic tools that are highly mobile and capable of performing complex molecular testing to generate rapid, reliable, and accurate diagnostic results, regardless of location.

Over the past decade, the field of genomics has seen drastic improvements in sequencing. Next-generation sequencing (NGS) is being applied to generate data across many disciplines. NGS instruments are becoming less expensive, faster, and smaller, and therefore are being adopted in an increasing number of laboratories, including clinical laboratories. Thus far, the clinical use of NGS has been mostly focused on the human genome for purposes such as characterizing the molecular basis of cancer or for diagnosing and understanding the basis of rare genetic disorders. There are, however, an increasing number of examples where NGS is employed to discover novel pathogens, and these cases provide precedent for the use of NGS in microbial diagnostics. NGS has many advantages over traditional microbial diagnostic methods, such as unbiased rather than pathogen-specific protocols, the ability to detect fastidious or non-culturable organisms, and the ability to detect co-infections. One of the most impressive advantages of NGS is that it requires little or no prior knowledge of the pathogen, unlike many other diagnostic assays; therefore, for pathogen discovery, NGS is very valuable. However, despite these advantages, there are challenges involved in implementing NGS for routine clinical microbiological diagnosis.

Nucleic acid sequencing, along with most biological analyses, can be carried out in a wide variety of facilities. In general, testing locations can be broken up into two categories. First, large-volume centralized facilities often run high-throughput automated systems to handle large numbers of tests. These facilities require expensive equipment and highly trained personnel. High volume makes testing affordable. The second category is the point of care or field-testing facilities. Tests are run on the samples as they are taken and can provide immediate actionable results. This decentralized approach requires more hands-on efforts since large robotic systems are too expensive for placement in facilities with a limited number of samples to run. This is often a problem for resource-limited locations. The current invention is directed at use in decentralized testing facilities and resource-limited sites. It provides the ability to do rapid testing on-site when timely results are necessary.

There has been a strong interest in developing disposable cartridges for conducting analyses of biological samples for various diagnostic and monitoring purposes. For example, U.S. Pat. No. 5,587,128 to Wilding discloses devices for amplifying a preselected polynucleotide in a sample by conducting a polynucleotide amplification reaction. U.S. Pat. No. 5,922,591 to Anderson et al. describes a miniaturized, integrated nucleic acid diagnostic device and system. The device is generally capable of performing one or more sample acquisition and preparation operations in combination with one or more sample analysis operations.

U.S. Pat. No. 6,881,541 to Petersen et al. describes a cartridge that has been successfully commercialized by Cepheid to do limited sample processing, PCR amplification of target nucleic acid sequences, and detection of the resulting product. The '541 patent disclosed the use of a rotating disk with ports to valve multiple reagent chambers and fluidic channels. The claimed cartridge included a chamber for sonication, to disrupt samples. However, sample clean-up was limited, thus limiting the types of input samples that could be used without manual processing. In particular, the Cepheid cartridge can only process small-volume samples or those with minimal solid components that would plug the filter.

U.S. Pat. No. 8,663,918 to Connolly et al. disclosed a cartridge where fluid reservoirs were incorporated into the rotor of a rotary valve, rather than just using the rotating disk as a valve. The '918 patent allowed for additional processing steps to clean and concentrate nucleic acid molecules. This simplified alignment allows for more processes to be integrated into the cartridge. In particular, the '918 patent enabled the incorporation of sample processing into the cartridge to enable the lysis of a sample and separation of the nucleic acids.

In addition to PCR, there are other diagnostic technologies with various advantages and disadvantages. Isothermal detection eliminates the need for thermocycling but has a lower sensitivity level. Quantitative PCR has additional requirements but can provide the concentration of target material. CRISPR is a more recent diagnostic technology that can reduce time, allow for the amplification of the signal and provide relative concentration.

Many of the prior fluidic cartridges for processing fluid samples have focused on picoliter, nanoliter, and microliter sample volumes. These small sample volumes are not practical for many realistic diagnostic applications. Of special interest is the detection of target analytes (e.g., nucleic acid) that exist in low concentrations in many samples. For example, in detecting infectious diseases, gram-negative bacteria can be present at less than ten copies per milliliter of blood, cryptosporidium generally appears as only a few copies per gallon of drinking water, concentrated biothreat agents (e.g., anthrax) at less than 100 copies per milliliter of water, and food poisoning agents, such as E. coli and salmonella, may be manifested in less than ten copies per gram of food. Therefore, a key requirement is for a system to handle sample volumes in the hundreds of microliters to milliliter range to allow for sufficient material to be analyzed.

To be an effective solution for decentralized sequencing or other biological analysis, a system has several requirements. First, it must be easy to use with minimal training needed for personnel. The system must be durable and reliable, with limited maintenance requirements. Reagents need to be stable. Cost is also a critical factor, especially the cost of any disposable components. Smaller, more portable systems are also desired since space is often limited.

Testing genetic material is used in many fields: medical diagnostics, agriculture, forensics, food safety, biothreat identification, and product taggants. To test genetic material, it first must be isolated from a sample. These samples vary widely from medical samples (including blood, tissue, saliva, swabs, urine, feces, and sputum), food, environmental samples, soil, air filter extracts, etc. The analytical system needs to be configurable to a wide variety of sample inputs.

One object of the present invention is, therefore is to provide an apparatus for automatically performing analyses that is flexible and applicable to a wide variety of analyses. To achieve high flexibility, it is necessary to integrate as much functionality as possible into a system. Hence, solutions for increasing functionality without increasing complexity, cost, and/or sensitivity are required.

Another object of the present invention is to provide an automatic system in which human intervention is reduced to a minimum and operational errors are avoided.

Another object of the present invention is to provide an automatic system that is robust and not sensitive to contamination.

Another object of the invention is to provide a design and method for automatically inactivating any pathogenic material in the cartridge after the assay is run and before disposal.

Another object of the invention is to provide a disposable cartridge that allows for stable storage of dried reagents without the need for refrigeration.

Another object of the invention is to provide and system and method for agnostically diagnosing infectious diseases from patient samples.

### BRIEF SUMMARY OF THE INVENTION

The current invention provides a disposable cartridge for the automation of complex chemical and biological processes.

The current invention comprises a disposable cartridge consisting of a shuttle which is inserted on a rail (within a housing). The shuttle element comprises two external planar surfaces that contact planer internal side surfaces on the rail in the housing. The shuttle is movable, and as it moves, it opens and closes ports for fluidic channels and chambers, acting as a valve. One or both of the planer surfaces may have a compliant coating to ensure good contact with the rail. One or more syringes located on the housing are fluidically connected to the shuttle via the ports. The syringes introduce or remove fluids or air from the shuttle chambers. The shuttle may comprise one or more reservoirs for containing reagents. The top or the bottom of the shuttle may also consist of one or more channels or reaction chambers. One or both sides of the shuttle may have ports that connect to the channels or reaction chambers to allow for fluids or air to move from outside the shuttle to the channels or reaction chambers.

### BRIEF DESCRIPTION OF THE DRAWINGS

FIG. 1 shows the shuttle (2) sitting in the rail of a housing (1). The shuttle is shown with multiple chambers for reagents. The shuttle is shown with two syringe barrels (3). The syringes make fluidic contact with ports in the lower portion of the side walls of the shuttle to form a fluidic connection with the chambers in the shuttle when the syringe and port are aligned. A chamber is also shown on the back side (opposite the syringe plungers).

FIG. 2 shows the shuttle showing reagent chambers (4) and fluid access ports (5) on the side wall. A flexible over-mold is shown covering the side walls and base of the shuttle to form a better seal between the shuttle and the housing. A second row of ports are shown, which align with ports in the rail to form a vent to avoid pressure changes in the reagent chamber when moving fluids.

FIG. 3 provides a top view of a housing (1) showing the channel for the shuttle. Openings (7) in the base of the shuttle allow access to reaction chambers in the base of the shuttle by the magnets and heaters. Openings for heaters would be larger and would allow heaters to make contact with the reaction chambers in the base of the shuttle. Reaction chambers (8) are also shown in the base of the housing, which can be used for heating, including thermocycling, and optical measurements. These reaction chambers have thin film walls on two sides for optical measurements or dual-sided thermocycling heating. An overflow chamber (6) is shown which is fluidically connected to the reaction chambers in the housing to allow for pressure relief during filling.

FIG. 4 provides a bottom view of a variation of a Housing (1) showing chambers (8) and flow channels (9). An opening for access to the base of the shuttle is also shown (7).

FIG. 5 shows an overview of a potential layout of reagent chambers for sample and library preparation. This is a top view and does not show the reaction chambers in the base of the shuttle. This figure shows that the sample preparation reagent chambers are larger to handle about one milliliter of sample. The library preparation chambers are smaller to minimize the amount of enzymes needed. This version shows reagent chambers in both the shuttle and the housing. On the left, larger chambers are used for sample preparation. The first chambers (L1 and L2) contain the lysis buffers and magnetic particles. The next chamber(S) is a sample chamber. The sample chamber is large enough to contain sufficient sample material for testing. Preferably, the chamber is between 0.5 and 3 milliliters in volume. The sample chamber must have sufficient volume to hold the sample to be tested and the lysis buffer with the magnetic particles. Alternatively, the two chambers may be merged, and the lysis buffer is preloaded into the sample chamber. After the sample and lysis buffer are combined, they are mixed and then if needed sonicated to disrupt the sample. After disruption, the disrupted sample and magnetic beads are pushed through a chamber at the bottom of the shuttle which is located directly above a magnet. Magnetic particles are collected in a chamber in the base of the shuttle. The shuttle is moved to allow the syringe to pull in the magnetic particle wash buffer (MW). After washing, including disruption with sonication, the nucleic acids are eluted from the pellet using the elution buffer (ME). In this iteration of the cartridge shows the dry reagent chambers are located on the housing (D). Enzyme resuspension buffer (EB) and resuspension buffer (R) are located in the shuttle.

FIG. 6 shows a bottom view of the shuttle and the wings of the housing with a layout of reaction chambers. Multiple reaction chambers are shown in the shuttle base (10 and 11). Magnetic separation and heated reaction chambers are shown. In this iteration, the magnetic (11) and heated chambers (10) are linearly arranged in two offset lines. A dual-sided optical detection chamber is also shown in the housing base (12). This is only one option. All chambers may be in one line or alternatively shuffled. In a preferred embodiment the sonicator is in line with the magnetic separation chambers to allow for the chambers to be moved over both the magnet and the sonicator.

FIG. 7 shows a lid that covers the reagent chambers in the shuttle. Unstable reagents, such as enzyme mixes, are held on or in pins (13) that extend into chambers in the shuttle. The lid is stored separately from the housing, thus keeping unstable reagents separated for long-term storage. These reagents are directed to the appropriate chambers via their position on the lid. Multiple pins are incorporated in the lid to hold the necessary enzyme pellets for multiple steps.

FIG. 8 shows a dry reagent pellet (14) inserted into the end of a pin (13) on the lid.

FIG. 9 shows a cutaway view of the housing (1), shuttle (2), and lid (19).

FIG. 10 shows a close-up cutaway view of the housing (1), shuttle (2), and lid (19).

FIG. 11 shows a shuttle with multiple chambers on the upper surface. Ports are found on the outer face of the shuttle to allow a fluidic connection to the syringe barrels on the housing.

FIG. 12 shows a bottom view of a housing with a fluidic chamber and channel connections. In addition, an opening is shown that resides under the shuttle to allow physical contact of the reader to the shuttle. Possible needs for contact include magnets, heaters, and sonicators.

FIG. 13 shows a top view of a cartridge with the housing and shuttle. The shuttle is located partially out of the rail in the housing to give a better view of the shuttle ..

FIG. 14 shows a top view of a cartridge, including the shuttle and housing. A lid is also shown.

FIG. 15 shows a top view of the shuttle.

FIG. 16 shows a bottom view of the shuttle.

FIG. 17 shows an angled top view of the housing.

FIG. 18 shows a schematic of a reader with motors and a sonicator interfacing with a cartridge.

FIG. 19 shows a concept for packaging for a cartridge with a lid holding dried reagents.

FIG. 20 shows a cartridge shuttle designed for automation of an agnostic diagnostic cartridge to prepare pathogen nucleic acids from patient samples for sequencing.

FIG. 21 is a top view of the shuttle of FIG. 20.

FIG. 22 shows the base of the cartridge shuttle of FIG. 20. Multiple reaction chambers (10) have been included for multiple magnetic bead clean-up and thermal incubation steps.

FIG. 23 shows the shuttle of FIG. 21 in the housing of FIG. 20.

FIG. 24 shows the shuttle of FIG. 21 in the housing of FIG. 20 with a sample cap (25) and reagent storage lid (19).

### DETAILED DESCRIPTION OF THE INVENTION

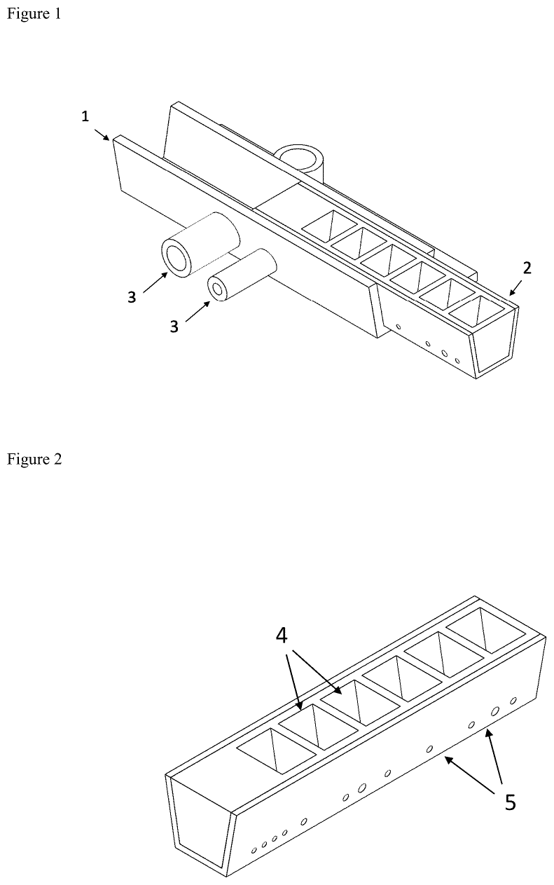

The present invention provides a system that automates complex chemical and biological analysis into an easy-to-use, automated disposable cartridge. The disposable cartridge utilizes a novel design with a shuttle on a rail in a housing (FIG. 1). The outer side walls of the shuttle contact the inner walls of the rail to form a seal. Ports in the walls of the shuttle and the rail allow for the valving of multiple fluidic channels by moving the shuttle along the rail. Locating the shuttle in various positions to align ports in the shuttle and the rail creates fluid paths that allow for the movement of fluids or air. Either the walls of the housing or of the shuttle which are in contact can be over-molded with a low durometer material to improve sealing. The linear design enables the device to move from step to step in a linear fashion, minimizing cross-contamination of reagents. The device is manufactured as two separate components.

The housing also has two or more syringe barrels. Each syringe barrel has a moveable plunger to pull in and expel fluids or air. A syringe motor drives the movement of a plunger in the syringe barrel. The motor is preferably a linear drive motor. The syringe barrel can be capped with a stripper cap that has a central opening for the plunger rod of the syringe motor to enter the syringe barrel and move the plunger. The stripper cap holds the plunger in the barrel when the syringe motor withdraws the plunger rod, restraining the plunger in the barrel and keeping the liquids sealed within the cartridge.

The syringe barrel is connected to a port in the rail wall. The port, which opens on the inside surface of the rail wall can be aligned with the ports on the shuttle to allow for the syringe shuttle reservoirs and reaction chambers to be fluidically connected. As the shuttle's two parallel exterior surfaces slide along the side walls of the housing rail, the port for a syringe can align with the plurality of chambers fluidly connected by a plurality of ports along the exterior surfaces at different positions, wherein sliding the shuttle aligns one of the shuttle ports with a fixed port on the housing such that fluid may be moved into and out of the chambers in response to displacement of the moveable plunger.

In a preferred embodiment of the invention, the disposable cartridge housing has two or more syringe barrels having at least two different volumes. The larger volume syringe is particularly useful for sample processing where larger volumes are preferred. Whereas the smaller syringe is preferred for enzymatic reactions where it is desirable to limit the fluid volume to lower costs.

Referring to FIG. 1 there is shown a shuttle set in the housing of the instant invention. The shuttle is held within the housing. The shuttle sits in a rail formed by two side walls and a floor in the housing. One or more syringe barrels are attached to the first side wall of the housing. Each syringe barrel houses a plunger, which can be moved by a plunger rod from the reader. A port in the side wall opens into the syringe barrel and to the internal surface of the side wall in the rail. When aligned with a port in the side of the shuttle, it allows for a fluidic connection between the syringe and a reservoir or chamber within the shuttle. The shuttle is a component containing a plurality of reservoirs opening on the top surface of the shuttle, which are capable of storing reagents, being used as a sample chamber, receiving waste, or for other purposes. Additional reaction chambers are in the base of the shuttle but not visible here.

Referring to FIG. 2, there is shown a top view of the shuttle of the instant invention. The shuttle has a plurality of chambers capable of containing fluids or dried reagents. Chambers can also be used to receive samples and to collect waste. Heat seal films, not shown cover the top and bottom surfaces of the shuttle and seals the chambers from the outside environment. Each chamber has a port in the lower portion of the wall, which can be aligned to a port in the housing, which is in fluidic connection to a syringe. This allows for fluids to be moved in or out of the chamber using the syringe. A second port is located in the upper portion of the side wall of a chamber that can be aligned with a port in the housing. This port, when aligned with the port in the housing wall, creates a vent to allow for air to move in and out of the chamber when the syringe is actuated to prevent back pressure or negative pressure within the chamber.

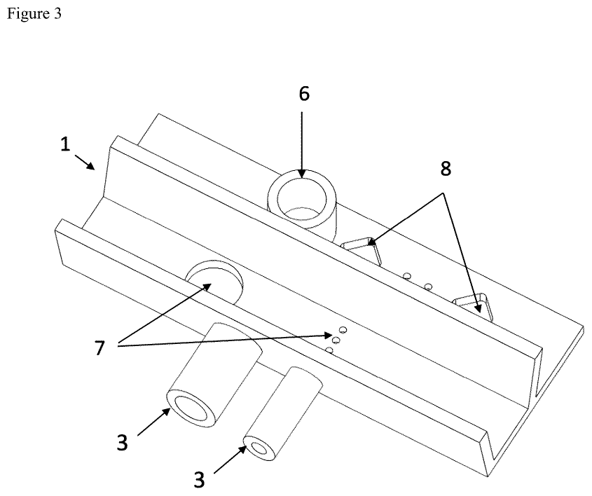

Referring to FIG. 3, a view of the housing is shown. The housing consists of a rail with two side walls, a base, and one or more syringe barrels. The side walls may be slightly angled out from the channel. A snap feature may also be included along the top of the side walls to hold the shuttle in place. Supporting ribs may also be located perpendicular to the side walls outside of the channel to support the side walls and to maintain pressure on the seal with the shuttle. Openings in the housing base inside the channel allow for various components from the system to directly contact the base of the shuttle. Such components include but are not limited to magnets, sonicators, or heaters (including thermocyclers). Chambers with a heat seal forming the top or bottom or both of a chamber may also be located in the base. Such a chamber may be used for heating or for optical access to carry out optical measurements. FIG. 3 shows an apron on the side opposite the syringes. Aprons may be located on either side of the rail. The apron shown depicts two reaction/optical chambers and a reagent chamber or overflow chamber. The reaction or optical chambers are sealed on the top and bottom with a plastic film to enclose the chamber. If optically transmissive films are used, the chamber can be used for optical measurements of materials in the chamber. The chamber may also be used for a variety of processes not limited to sonication, heating (including thermocycling), and magnetic separation.

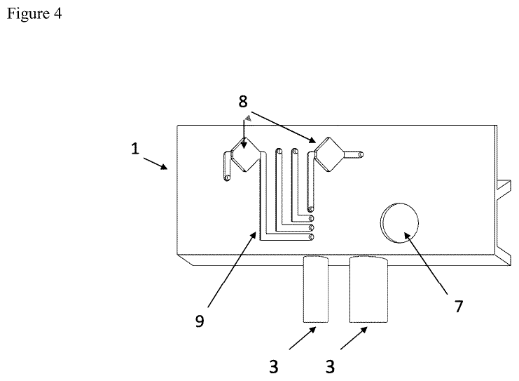

FIG. 4 shows a bottom view of a housing with chambers and flow channels. The chambers and flow channels are completed with a thin plastic seal covering the chambers and/or channels. The chambers are in a fluidic connection to the syringes via the channels. An opening is also shown in the base of the rail. A cartridge may have multiple openings in the base of the housing. Openings in the base of the rail of the housing can be used to allow access to the bottom side of the shuttle. A variety of components can access the bottom of the shuttle, including sonicators, heaters (including thermocyclers), optical sensors, and magnets.

FIG. 5 shows a layout of chambers for the cartridge. In this layout, there is a plurality of larger chambers for sample processing. These larger chambers preferably can hold more than 100 microliters of solution and more preferably more than 500 ul of solution.

The chambers may be of different volumes. One or more chambers may be used to receive the test sample. In this configuration, there are chambers to hold lysis buffer (L1 and L2), magnetic particles (MP), a wash buffer (MW), and an elution buffer (ME) in addition to the sample chamber(S). A desalting column (C) is also included. Smaller chamber chambers are then used for library preparation. These chambers include the magnetic particle, wash buffer, and elution buffer. A resuspension buffer is also included to rehydrate dry reaction mixes and to dilute the final sample if needed. These smaller chambers are typically designed to hold less than 100 microliters of solution. More preferably the volume of solution is less than 50 microliters. If needed, reagent chambers may also be located in the housing. Several small chambers are shown in this interaction of the design to hold dry reagents in the housing. The diamond-shaped chamber is an optical detection chamber to measure the final concentration of the nucleic acids prior to analysis. In this layout, a waste chamber is shown. Preferably, all waste is contained in the cartridge for easy disposal. More than one waste chamber may be included in the cartridge. This depiction shows how dried reagents may be located in the housing. In that case, wet reagents can be stored in the shuttle and dry reagents in the housing to increase the shelf life of the dried reagents. The two components are stored separately and snapped together just before use.

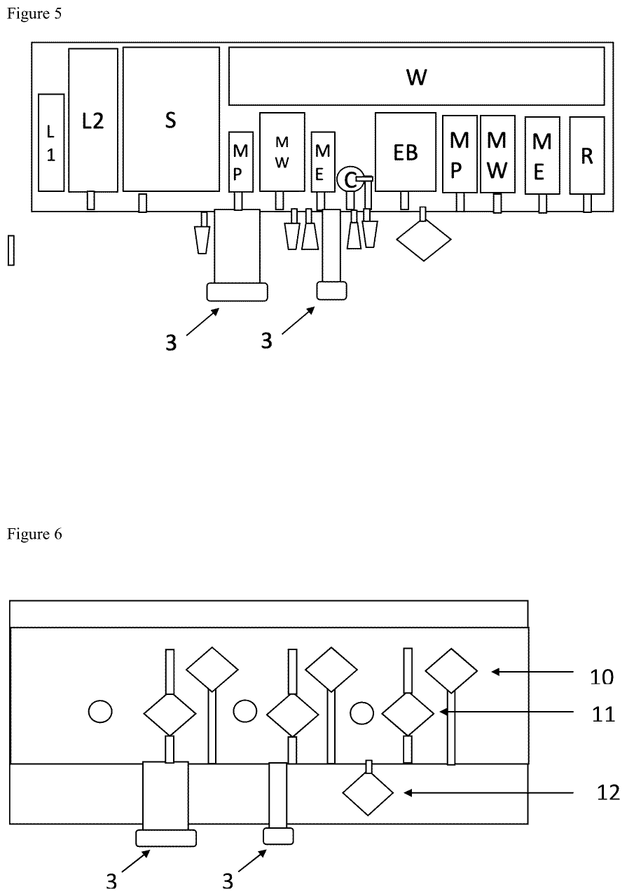

FIG. 6 shows a schematic laying out one possible arrangement of chambers on the bottom surface of the shuttle. A series of chambers for heating and magnetic separation are depicted. The chambers will typically be located along a line running the length of the shuttle so that the chambers will move over a stationary sonicator, heater, or manet as the shuttle slides along the rail. Preferably, a sonicator and magnet in the system will be located in line with one another so that particles can be pulled down with a magnet with the shuttle in one position and then moved over a sonicator when the shuttle is moved to a second position in order to resuspend the particles. In this figure, two lines of reaction chambers are shown. The top line of diamond-shaped chambers can be used for thermal reactions, with each chamber being moved over a heater. The second line of chambers is able to align each chamber with a sonicator and a magnet. The chamber can be moved over the magnet to attract and collect the magnetic particles into a pellet. The chamber can then be moved over a magnet in order to disperse the magnetic particles for washing and elution. One or more lines of chambers may be included as needed. The number of chambers in each line may also be varied as needed.

In one embodiment of the invention, the cartridge has one or more chambers in the base of the cartridge shuttle, wherein the chamber or chambers can be moved over a magnet and also over a sonicator or other source of disruptive energy.

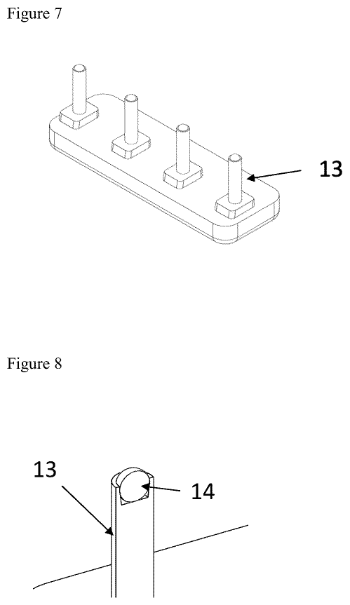

FIG. 7 shows a lid with pins holding dried or frozen reagents. When the lid is placed on the shuttle, the pins introduce the reagents to the chambers, where they can be rehydrated or melted prior to use. The pin may be any structure that can restrain the solid reagent and hold it in position in the appropriate chamber.

FIG. 8 shows a cutaway view of a pin holding a dry reagent pellet. In this embodiment, the pin is held within a recessed opening at the end of the pin. Any configuration that can restrain the dried reagent while making it accessible to the resuspension solution is acceptable.

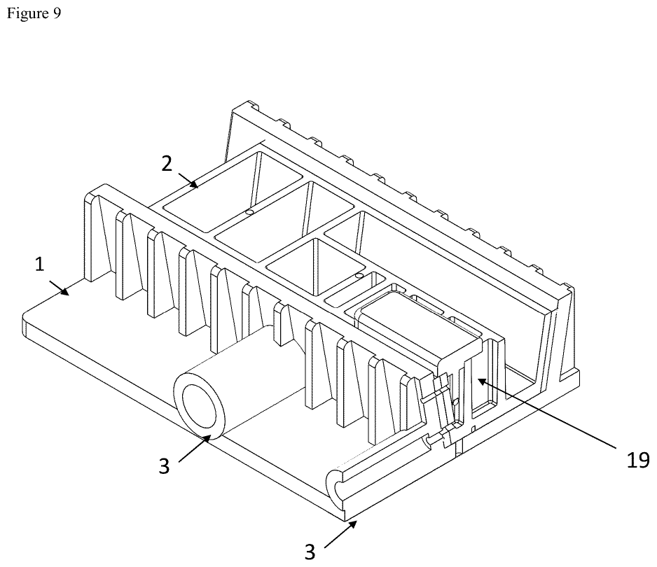

FIG. 9 shows a cutaway view of the housing and shuttle with the lid attached. In this view, the small syringe is shown connecting to a chamber with a pin from the lid. Each of the pins in the lid goes to a separate chamber in which the dried reagent attached to that pin can be dissolved and activated. The syringe can push a resuspension buffer into the chamber to dissolve the dry reagent and activate the solution.

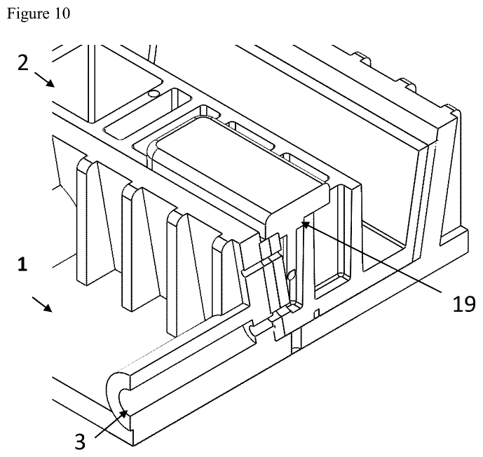

FIG. 10 shows a close-up of the view in FIG. 9.

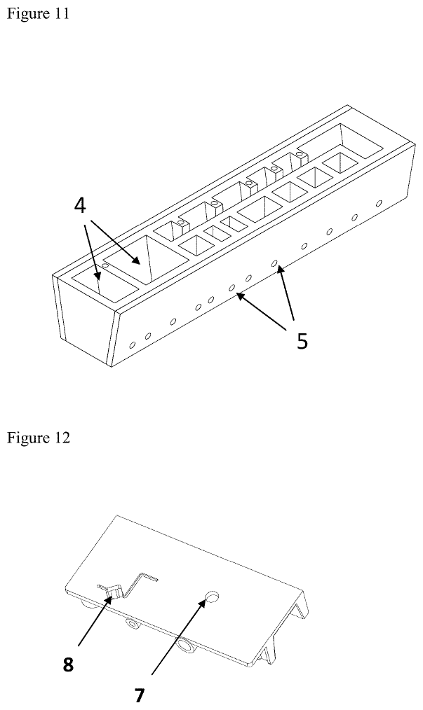

FIG. 11 shows a top view of a shuttle. In this shuttle, large chambers (4) are shown at one end, with smaller chambers (4) extending toward the other end. Ports (5) in the base of each chamber or leading to reaction chambers in the base are shown along the base of the side wall. Vent ports are not shown. A larger waste chamber is shown running behind the smaller chambers. Within the waste chamber, a number of vent stacks are shown, which extend from a channel that connects to the reaction chambers in the base, These vent stacks allow for air to exit the chambers during filling to prevent back pressure.

FIG. 12 shows a fluidic chamber (8) with channels in the base of the housing. An opening (7) for a component in the system to access the base of the shuttle is also shown. One or more openings may be in the base of the housing to allow access to the base of the shuttle.

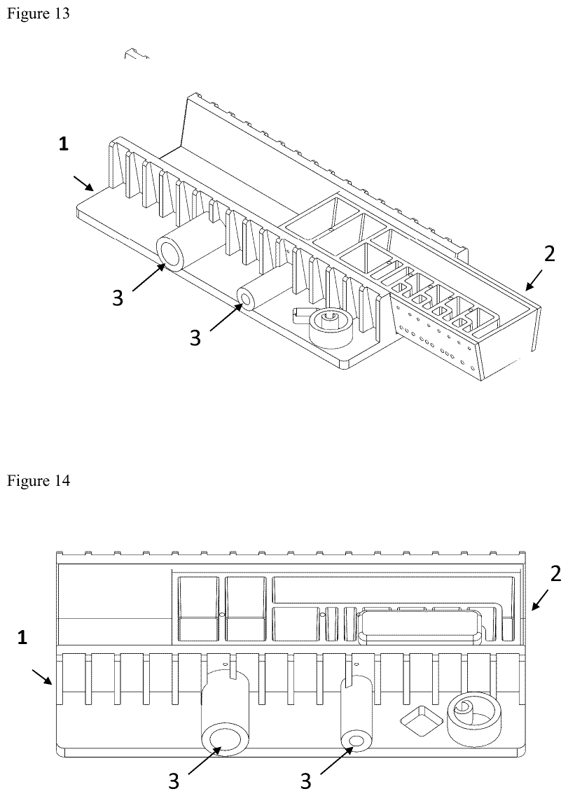

FIG. 13 shows a top view of a cartridge with the shuttle (2) in the housing (1), with the shuttle slid out to better show the shuttle.

FIG. 14 shows a top view of the cartridge with the shuttle (2) in the housing (1) and with the dry reagent lid (19) attached. No top film is shown.

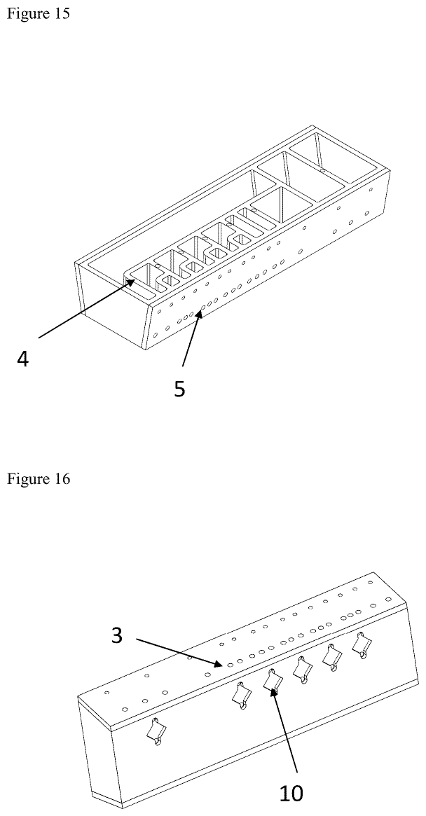

FIG. 15 shows a shuttle with an alternative layout of reagent chambers (4) and ports (5). Additional chambers and ports have been added to increase the number of steps that can be automated in a single cartridge.

FIG. 16 shows an alternative shuttle design with additional reaction chambers (10) in the base.

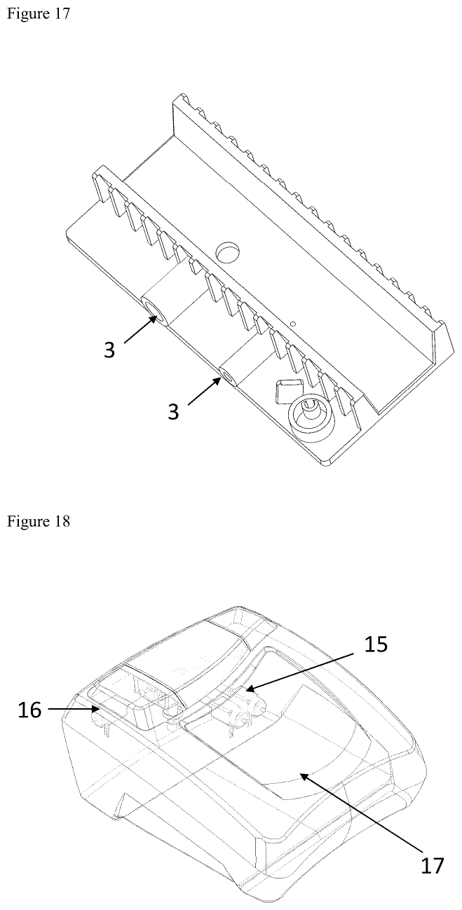

FIG. 17 shows an alternative cartridge housing.

FIG. 18 shows a system to run the process in the cartridge. The cartridge is located under a lid in the top rear of the device. A touchscreen display (17) sits forward of the cartridge bay and angles downward. A motor is shown engaging the end of the shuttle in the cartridge, which moves the shuttle in the housing (16). Two motors are shown to move the plungers in the syringe barrels (15). A sonicator is shown coming up against the base of the cartridge to be able to sonicate samples in the cartridge.

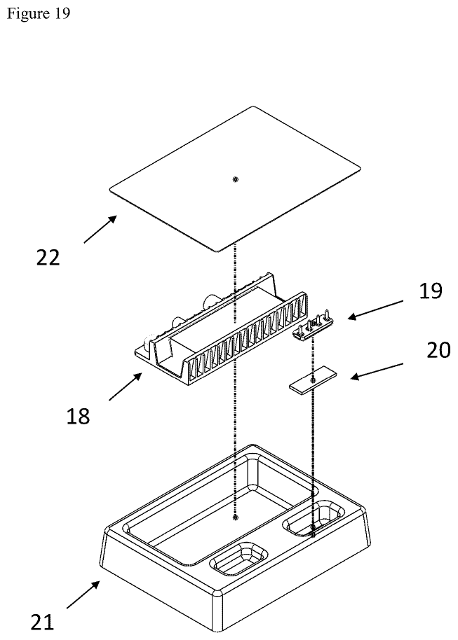

FIG. 19 shows the packaging for a cartridge with a lid holding dried reagents. A plastic tray (21), preferably a vacuum-formed tray, has recessed areas to hold the cartridge, the lid (19) with dry reagents, and the sample cap. The lid with dry reagents is packaged with a desiccant (20) to keep the dried reagents stable. The cartridge assembly (18) with the housing and shuttle (including heat seals) is packaged separately from the lid with dried reagents. A film seal (22) is attached to the top of the tray.

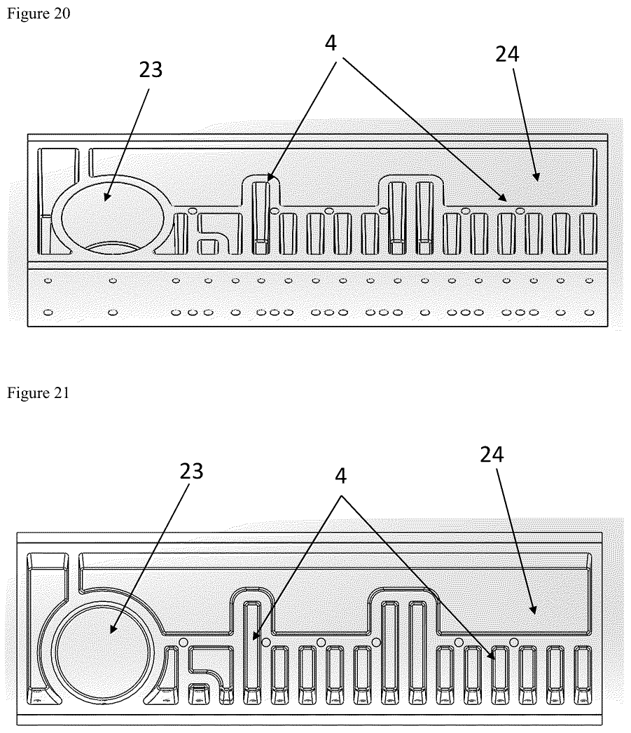

FIG. 20 shows a cartridge shuttle designed for automation of an agnostic diagnostic cartridge to prepare pathogen nucleic acids from patient samples for sequencing. A round sample chamber (23) holds the patient sample. Additional reagent chambers (4) have been incorporated to enable pathogen enrichment and non-specific nucleic acid amplification to improve sensitivity. A larger waste chamber (24) has also been designed to handle the additional reagents needed.

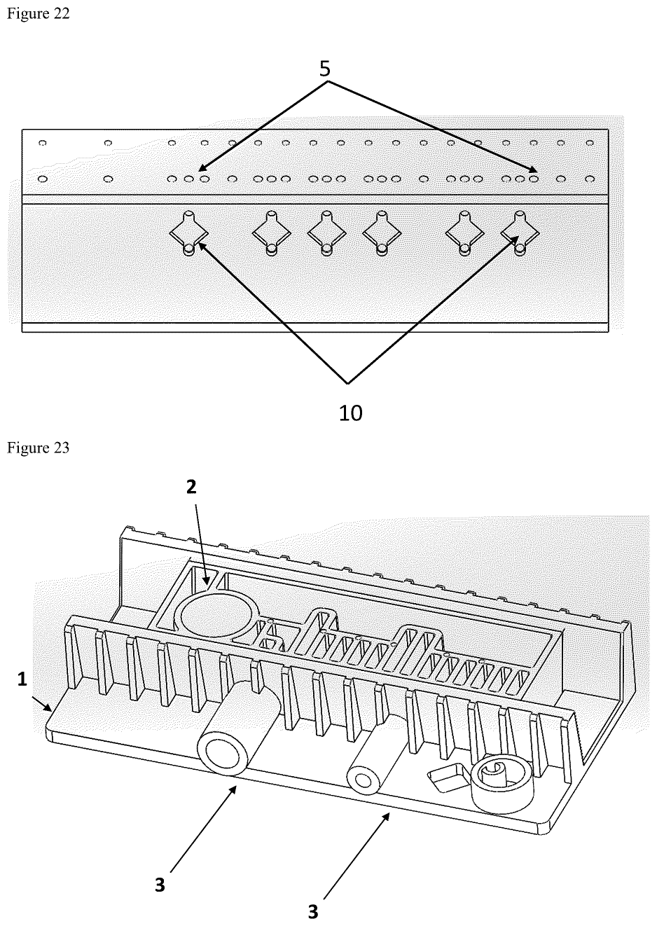

FIG. 21 is a top view of the shuttle of FIG. 20.

FIG. 22 shows the base of the cartridge shuttle of FIG. 20. Multiple reaction chambers (10) have been included for multiple magnetic bead clean-up and thermal incubation steps.

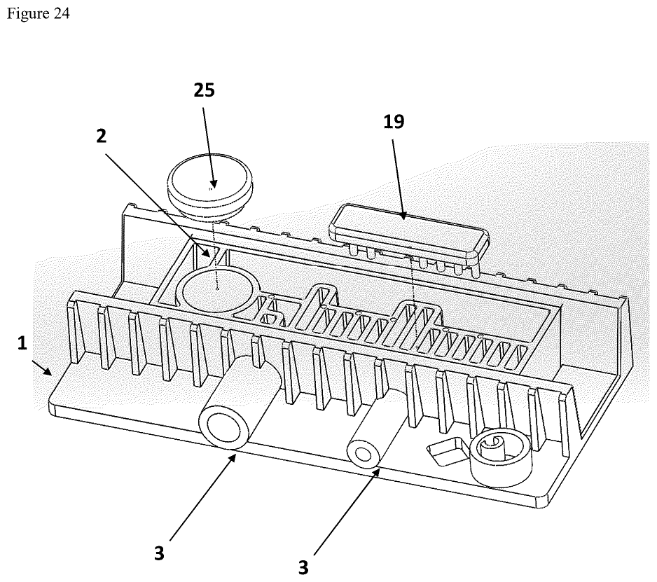

FIG. 23 shows the shuttle of FIG. 21 in the housing of FIG. 20.

FIG. 24 shows the shuttle of FIG. 21 in the housing of FIG. 20 with a sample cap (25) and reagent storage lid (19).

The shuttle and housing are preferentially made of an injection molded plastic. An over-molded compliant material may also be used on the sealing surfaces of the shuttle and or housing. Ports are located on the sealing surface to allow the movement of fluids between the shuttle and the housing. The upper side of the shuttle has multiple chambers for fluids. The bottom of the shuttle has channels for moving fluids and reaction chambers which can interface with the sonicator, magnets, and heaters of the reader. Some fluid chambers may be open on the bottom of the shuttle. Chambers open on the base of the shuttle will also connect to a channel in the base of the shuttle to allow a fluidic connection to the ports. The top and bottom of the shuttle are sealed with a plastic film. This will contain reagents in the shuttle. A film using aluminum or other material to prevent water vapor transfer can be used to improve the shelf life of the disposable and its reagents.

The housing comprises a rail with two planer surfaces that contact the two planer surfaces on opposite sides of the shuttle. The planer surfaces contacting the shuttle may be covered with a compliant coating to enhance sealing between the shuttle and the rail.

The housing also comprises one or more syringe barrels. A syringe comprises a cylindrical barrel and a plunger. An external motor engages the plunger to move fluids with the barrel. The plunger pushes or pulls fluids into or out of chambers or channels in which it is fluidically connected. In a preferred embodiment of the invention, the syringe is driven by a linear shaft motor. Each syringe barrel is connected to a port that opens out through one of the planar surfaces of the rail. When a port for the syringe barrel is aligned with a port from the shuttle, it forms a path for fluids or air to move from the syringe to the reaction chamber or channel in the shuttle. The syringe barrel preferably has a lip or cap to retain the plunger in the barrel as the drive shaft is removed.

The housing also comprises chambers for the storage of reagents. In particular, the housing contains the dried reagents in a preferred embodiment of the invention. The housing may also contain additional chambers to hold waste, desalting columns, and reaction or detection chambers.

In a preferred embodiment of the invention, the housing has at least two syringe barrels with different internal volumes. In many processes, different volumes of reagents are handled. A large syringe has a larger variability of volumes moved and results in significant inefficiency when small volumes are handled. For example, in sample processing and library preparation for DNA sequencing, larger volumes are needed for sample processing and smaller volumes for library preparation. In a preferred embodiment of the invention, the larger syringe has a volume greater than 100 microliters. In a more preferred embodiment, the volume of the larger syringe is greater than half a milliliter. A volume of one milliliter is preferred. A larger volume allows for a larger sample and therefore, more target to be analyzed. However, as volume increases, the size of the cartridge and costs will increase and must be considered.

Ports for channels, reaction chambers, waste chambers, or venting other than liquid chambers could be located on either face of the shuttle. The linear configuration allows for a step-wise progression of handling steps to occur as the shuttle moves down the rail. Minimizing movement backward will prevent cross-contamination of reagents during the process being run in the cartridge. However, the shuttle may be moved in either direction during a procedure.

For library preparation, multiple enzymatic steps may be required. Smaller volumes are desired due to the cost of the enzymes, so many enzymatic reactions are carried out in volumes of 10-50 microliters. Sample sizes need to be sufficiently large to ensure that a target will be present. In a preferred embodiment, the volume of the first syringe barrel is 100 microliters or greater, and the second syringe barrel volume is 100 microliters or less. Preferably, the volume of the smaller syringe is less than 30 microliters.

The cartridge with the sample is inserted into the reader or system. The processing unit has a motor that moves the shuttle along the rail in the housing. Preferably, the motor is a linear drive motor. The system also has one or more linear actuators to move the plungers in the syringe barrels. The system may also have one or more magnets, heaters (including thermocyclers), and sonicators. The magnets, heaters, and sonicators are positioned to contact the cartridge. The magnets, heaters, or sonicators may be actuated to come into contact with a portion of the cartridge when needed. The system also has electronics to control the motors, heaters, sonicators and any active actuating mechanisms.

The shuttle is preferentially made of an injection molded plastic. An over-molded compliant material may also be used on the sealing surfaces of the shuttle. Ports are located on the sealing surface to allow the movement of fluids between the shuttle and the housing. The upper side of the shuttle has multiple chambers for fluids. The bottom of the shuttle has channels for moving fluids and reaction chambers which can interface with the sonicator, magnets, and heaters of the reader. Some fluid chambers may be open on the bottom of the shuttle. Chambers open on the base of the shuttle will also connect to a channel in the base of the shuttle to allow a fluidic connection to the ports. The top and bottom of the shuttle are sealed with a plastic film, preferably a heat-activated sealing film. This will contain reagents in the shuttle. A film using aluminum or other material to prevent water vapor transfer can be used to improve the shelf life of the disposable and its reagents.

The housing comprises a rail with two planer surfaces that contact the two planer surfaces on opposite sides of the shuttle. The planer surfaces contacting the shuttle may be covered with a compliant coating to enhance sealing between the shuttle and the rail.

The housing also comprises one or more syringe barrels. A syringe barrel comprises a cylindrical barrel and a plunger. An external motor engages the plunger to move fluids with the barrel. The plunger pushes or pulls fluids into or out of chambers or channels in which it is fluidically connected. In a preferred embodiment of the invention, the syringe is driven by a linear shaft motor. Each syringe barrel is connected to a port that opens out through one of the planar surfaces of the rail. When a port for the syringe barrel is aligned with a port from the shuttle, it forms a path for fluids or air to move from the syringe to the reaction chamber or channel in the shuttle. The syringe barrel preferably has a lip to retain the plunger in the barrel as the drive shaft is removed.

The housing also comprises chambers for the storage of reagents. In particular, in one embodiment, the housing contains the dried reagents in a preferred embodiment of the invention. The housing may also contain additional chambers to hold waste, desalting columns, and reaction or detection chambers.

For sample processing, the sample chamber can be in the shuttle or the housing. In a preferred embodiment, the sample chamber is in the shuttle. The sample chamber is preferentially cylindrical with an internal curved bottom surface with a point of the chamber having the lowest surface and sloping up to the sides. A port is located at the low point and is fluidically connected to a syringe. This will allow the particulates to slide down to the center for better mixing when sonication is used. The sample chamber in the shuttle should be positioned over the ultrasonic head in the reader to disrupt and or mix the sample with lysis buffer and magnetic particles.

In one embodiment the system has a disruptor. The disruptor is capable of mixing or breaking down the fluids contained in the reservoirs by applying an ultrasonic force. A preferred disruptor is a piezoelectric driven sonicating horn. In one embodiment of the invention, beads are in the disrupting chamber or reservoir to assist in mixing fluids or breaking down samples. The sonicator applies ultrasonic energy, causing the beads to become excited and move through the fluid. In one embodiment a magnet is utilized to generate a magnetic field. The magnet can pull or push magnetic particles in a chamber.

A basic sample lysis procedure would be to introduce the sample into the sample chamber. Add lysis buffer to the sample. Lysis buffers may contain detergents, salts, buffers, and chaotropic agents. A preferred chaotropic agent is guanidine hydrochloride or guanidine thiocyanate to disrupt proteins. Chaotropic agents are particularly useful in the disruption of viral protein coats. Magnetic particles are also added to the sample. Commercially available magnetic particles are available with a variety of binding properties. The particles are paramagnetic, and magnetic in the presence of a magnetic field. Nucleic acids bind to the particles under specific conditions and can be selectively pulled out of the sample mixture. The mixture of the sample, lysis buffer, and magnetic particles is designed to enable efficient binding of the target material to the magnetic particles. Once the particles are mixed with the sample and lysis buffer, the sample is passed over a magnet to collect the particles with the bound nucleic acids. The particles are washed to remove residual material.

Preferably, the pellet of magnetic particles is resuspended and drawn back down with the magnet. Resuspension can be carried out by moving the wash buffer back and forth with the syringe over the pellet or with the disruptor. After washing, air can be pushed over the pellet to remove the wash buffer. An extraction buffer is then put into the chamber, the pellet resuspended and again pulled down. The extraction buffer is then removed with the nucleic acids. Disruption of the magnetic beads is important to effectively remove inhibitory compounds that otherwise could be trapped within the pellet. In addition, disruption will improve the elution of the target-bound molecules from the pellet. Without disruption, some of the target material can remain caught within the pellet, lowering the overall efficiency of the process.

In one embodiment, liquid reagents are stored in one component, preferably the shuttle and dry reagents are stored in the other component, preferably the housing. In one embodiment of the invention, the shuttle is filled with liquid all the required reagents, and stored separately from the housing. For storage, the ports on the shuttle can be covered with a removable film to seal the shuttle while it is outside the housing. The film should cover both the fluid transfer port and the vent port for the chambers. A snap mechanism can be used to lock the components together. Before use, the film can be removed and then the shuttle inserted and snapped into the housing. This allows for liquid and dry reagents to be stored separately to maximize shelf life. Each component would be separately packaged. In a preferred embodiment, each component would be packaged in a plastic pouch with an aluminum foil layer or other water barrier incorporated to keep water transfer to a minimum during storage. By separating wet and dry reagents, it is possible to ensure the stability of sensitive reagents such as enzymes to remain active for one or more years without refrigeration.

Preferentially, all ports on the shuttle connecting to a chamber holding a liquid reagent would be located on the same face of the shuttle, including both access ports for the fluid and vent ports for each chamber. This would allow for only one removable seal to contain all liquid reagents.

During storage of the shuttle separately from the housing, a seal is applied to cover ports including vent ports on one face of the shuttle. After removal of the seal, keep the ports on the upwardly facing side of the shuttle and insert the shuttle into the housing keeping the ports facing upwards until the shuttle is snapped into the housing.

The reader can provide additional pressure on the shuttle to maintain an effective seal with the shuttle. In one embodiment Post with a taper to match the taper on the outside of the rail protrudes through the base of the cartridge and pushes against the outside walls of the rail. These posts prevent the rail walls from splaying outwards and maintain pressure on the shuttle. In addition, the reader can push down the top of the cartridge to maintain the pressure of the shuttle walls against the inside surfaces of the rail.

The present invention also provides chambers for restraining freeze-dried pellets without the need for a restraining component. In the Cepheid cartridge, a plastic retaining bed is pushed in above the dried pellets. This keeps the pellet in the bottom of the chamber accessible by fluids that are moved into the chamber during operation. Without restraint, the pellet can bounce around the chamber during handling and can be broken apart into a powder that can stick to surfaces. Some of the powder may be above the fluid fill line, resulting in variability in reagent concentrations. To eliminate the need for a restraining component, a novel chamber design is provided. Chambers comprise side walls and a bottom or top wall. Due to molding constraints only a bottom or top wall can be molded. The final wall of the chamber is formed using a film seal over the top or bottom of the insert or housing. For purposes of holding the dried pellet, the chamber is molded from the bottom with a top wall to hold the pellet against the film seal which is the bottom wall, where the top wall is set high enough to hold the dried reagent against the bottom seal. A vent port is formed in the top wall to allow fluid to be pushed into the chamber. Alternatively, the top wall may be a grid or have multiple openings. The chamber is fluidically connected to the syringe via a channel in the base of the shuttle and ports up to and across to the syringe.

The shuttle is engaged by a drive motor in the system. Once snapped into the cartridge the motor engages the shuttle and then homes itself before beginning the protocol that is programmed. Preferably, the shuttle movement is minimized to prevent cross-contamination of reagents. In a preferred mode, the shuttle moves in the same direction that it will during the protocol and homing to maintain the linear movement of the shuttle from one end of the rail to the other. The shuttle can be moved back to an earlier position if needed and in some cases may be moved repeatedly in the back direction. Preferably, any backward motions will be for a limited distance. It is most desired to prevent reagents that could inhibit other steps from crossing by ports for those reagents used later in the process.

As the shuttle moves, some components in the reader will preferably be actuated to contact the base of the shuttle or housing in certain positions. Those components include magnets, heaters, and ultrasonic heads. Actuating these components minimize wear on the components in the reader and minimize the potential of tearing the film seal on the shuttle as it moves. Each component can be actuated actively with a motor drive. A preferred method would be passive. In that embodiment, actuated components would be spring-loaded to push up against the base of the shuttle or housing. Furthermore, spring-loaded components can make firmer contact with the base of the cartridge component, improving heat transfer, transfer of sonic energy, or magnetic pull.

Features on the bottom of the shuttle can hold the spring-loaded components at a level such that they do not contact the base of the shuttle or housing except when the shuttle is in a position where a step will occur requiring that component. At that point, the feature would allow the spring to push the component up against the base of the shuttle or housing. For example, a component is connected to a bar that rides along the base of the shuttle. As the shuttle moves the feature connected to the bar would have space for the bar to move upwards when it is in the position where contact is desired with the base of the shuttle. Such components include, but are not limited to heaters, piezoelectric heating and cooling, magnets, and sonicators.

The linear design of the shuttle provides several advantages over prior art rotary cartridges, which have been discussed in the background section. In a rotor valve, ports are limited to a segment of the circumference of the rotor due to the need for the pins to be parallel to one another in the molding process. As the number of chambers is increased, the diameter of the rotor must also increase and may result in dead space in the interior of the rotor. A shuttle length can be modified without resulting in major changes to the reader if additional space is open at the ends of the disposable cartridge in the unit. The rotor designs of both the Cepheid and INT cartridges also have potential risks due to the interaction of incompatible reagent risks due to the rotor sweeping ports of chambers containing reagents past the syringe or other ports in the housing of the cartridge. Optimizing the cartridge layout can minimize cross-contamination, but for complicated processes, this is not always possible. A linear layout minimizes the reverse motion needed to access the chamber or ports.

The shuttle faces with ports must seal against the faces of the rail such that the ports may align. In this position, the two components must make a seal to prevent liquid from leaking. When the shuttle is snapped into the cartridge, the snap mechanism should hold the parts together with pressure on the sealing surface. In addition to the snap mechanism providing pressure on the seal, the lid of the device or other mechanical force from the device may be used to maintain pressure on the seal to prevent leakage.

For a system to be readily utilized in resource-limited environments, there is a need to optimize the shelf life of the disposable cartridge. For example, the Cepheid Xpert MTB/RIF cartridges are the most commonly utilized test for tuberculosis. Tuberculosis is primarily a disease occurring in resource-limited areas. However, the Cepheid test cartridge with reagents needs to be stored at 2-28 °C, following the manufacturer's recommendations. The manufacturer states that the cartridges are stable if kept at 2-45 °C for less than six weeks at 75% relative humidity. The cartridges are bulky when packed and require substantial storage space. An average household refrigerator can hold the supplies needed for two can may pose challenges in relatively inaccessible areas that have complex customs clearance procedures. Planning is essential to prevent stock-outs and cartridges from expiring before they are used; orders should be based on the number of cartridges that have been used, the shelf-life of the cartridges, the lead time for delivery, and the expected time needed to clear customs. A need exists for a disposable cartridge that is stable without refrigeration for a longer period. Preferably, the cartridge and reagents would be stable for a minimum of three months without refrigeration. More preferred, the cartridge and reagents would be stable for a minimum of six months or even twelve months without refrigeration.

To ensure the stability of lyophilized reagents in a disposable, the current invention provides that the wet and dry reagents are stored separately in different components of a disposable where the components are snapped together before use. This can be done in several formats but the wet reagents should be stored separately from the dry reagents. Freeze-dried reagents are extremely hydroscopic and enzyme activity can be seriously degraded with small amounts of water.

In a preferred embodiment of the invention, the housing contains all dry reagents and is packaged separately from the shuttle. The shuttle would contain all wet reagents. To restrain the dry reagents to prevent them from moving during handling of the cartridge, which can result in the disruption of the dried material, the chambers holding the dried reagents may have a perforated barrier molded into the chamber. The dried material, preferably a pellet, is placed in the chamber with the shuttle inverted so that the pellet rests on the perforated barrier. Once all dry reagents are located in the appropriate chambers, the base of the shuttle is sealed with a film. The film may be attached by any compatible method, not limited to welding, heat sealing, or an adhesive. The dried material is then held between the film and the barrier to limit its movement during shipping and handling. A fluidic channel is formed between the molded shuttle and the film to allow fluid to be introduced into the chamber to dissolve the dry reagent. A vent port is located above the perforated barrier to allow air to move in and out of the chamber as fluid is moved.

In an alternative embodiment, the dry reagents are incorporated into a lid that interfaces with the shuttle. The disposable is stored in two parts and combined just before use. This allows unstable reagents to be stored dry, refrigerated or frozen while the remainder of the cartridge with stable components can be stored under ambient conditions. In biological processes, some reagents, especially enzymes, are unstable at room temperature or higher temperatures and require freezing or refrigeration to provide a useful shelf life. This creates significant additional costs in shipping and storage.

In a preferred embodiment, a lid which holds the unstable reagents. The lid has a cap and one or more reagent-containing features. When inserted into a cartridge, the cap seals the top of the reagent chambers that receive the unstable reagents. When inserted, the lid aligns the reagent features into corresponding reagent chambers. For freeze-dried reagents, the lid can be stored in a separate packaging without any liquids. For liquid and frozen reagents, the lid can be stored separately from the remainder of the cartridge, minimizing the size of the components that require cold-storage.

In one embodiment, the reagent-containing feature is a pin. A dried or frozen regent pellet may be attached to the pin. Alternatively, the pin is hollow, and the dried, frozen or liquid reagent is contained within the pin. In another embodiment, the regent-containing feature is sealed with a film. The film may be a flat film over a chamber or maybe a film that forms a blister on a flat surface. When the feature is inserted into a reagent chamber, the film is ruptured to release the reagent or to make the dried reagent accessible to a buffer or water. Preferably the reagent-containing region is ruptured upon insertion into the reagent chamber. Alternatively, the reagent-containing feature has a removable film seal that is removed prior to insertion of the lid into the cartridge. In yet another embodiment, plungers or pins are seated in the top of the reagent-containing feature and are depressed to push the reagent out of the reagent-containing feature when or after it is inserted into the reagent chamber.

In one variation, a freeze-dried reagent is attached to or contained in the reagent-containing feature. A buffer or water can be introduced into the reagent chamber to rehydrate the freeze-dried reagent contained in or on the reagent-containing feature of the lid. In an alternative embodiment.

Dry reagents are located on features on the bottom side of the lid which locate the dry reagents in the appropriate chambers when the lid is placed on the shuttle. Preferentially, such a lid has features that ensure alignment with the appropriate chambers. The lid with dry reagents would be packaged separately from the remainder of the cartridge in a watertight package. No fluids would be present in the lid package, providing a dry environment for long-term storage.

Alternatively, the lid can hold all of the wet enzyme solutions so that they can be stored frozen. The lid would then introduce the reagents into the appropriate chambers of the cartridge where they can be thawed before use. This approach requires cold storage, but a smaller lid component can be stored frozen with the bulk of the cartridge stored separately without the need for cold-storage for the larger cartridge.

The invention provides a disposable cartridge for chemical or biological analysis, comprising a first component that holds lyophilized reagents and no liquid reagents, a second component that holds all liquid reagents, and wherein when the two components are assembled into a single cartridge, the liquid, and dry reagents are connected fluidically. The disposable cartridge can further comprise that the first and second components have multiple chambers for reagents, and channels or ports to move reagents within each component and between the two components.

Many biochemical processes can be automated within the cartridge, such as biological sample processing, nucleic acid sequencing, and diagnostics. Although the discussion refers to biological processes in more detail, the system and cartridge can automate any chemical analysis procedures as well.

Sample preparation is required for many biological analytical techniques. Target material, which can include nucleic acids, proteins, or other molecules, often must be separated and concentrated from the original sample before analysis.

For many analytical techniques, isolation of the target material is required. For nucleic acid testing or sequencing, this entails isolation of the nucleic acids from the sample. The ability to incorporate sample processing in this cartridge is a key differentiator from other technologies. For nucleic acid diagnostics or sequencing, nucleic acids must be released from the cells, viruses, or carrier material. Disruption of the sample can be carried out using chemical, enzymatic or mechanical disruption techniques alone or in any combination. A preferred method of sample disruption utilizes a chaotropic salt. Preferably the chaotropic salt is a guanidine compound at high concentration. If needed, sonication and/or detergents can also be used to facilitate sample disruption. In the case of tissue samples, whole insects or other larger structures, bead beating may be used with sonication.

A common chemical process for the disruption of cells and viruses is treatment with guanidine hydrochloride. Guanidine disrupts protein folding and is especially useful in the disruption of viral protein coats. Detergents are often used to disrupt membranes. A combination of both can be used for complex samples. Ionic strength can also be used to break open cells.

Many samples will also require mechanical force for disruption. Spores are small single cellular units that have a very durable coat. Larger samples such as tissue or even whole organism, such as mosquitoes can also be processed, but need mechanical disruption to break apart the sample. Disruption can be driven using sonication. Ultrasonic energy can be introduced into a sample chamber. Ultrasonics results in cavitation which creates pulses of energy that can break apart the sample. If needed, beads may be used in the sample. During sonication, the beads are agitated and move through the sample to crush and grind the material. Ultrasonication can disrupt cells, tissue, and other materials. Sonication can be done with or without the use of beads or other materials to beat or shear the sample. Sonication can also be used to heat samples or simply to mix reagents. U.S. Pat. No. 6,819,027 to Saraf discloses an ultrasonic control system that can be used with the cartridge of the present invention. Patent '027 provides a method to maximize efficiency by dynamically detecting and maintaining peak operational resonance frequency.

Sonication may also be used to heat or mix the sample. Input energy can be varied to control temperature. Mixing may be used, especially with magnetic beads that may not disperse after being collected. Disruption may facilitate washing the beads to remove inhibitory materials.

Once a sample is disrupted, the target material may need to be cleaned and or concentrated before analysis. A readily available approach for cleaning and concentrating materials is the use of magnetic separation. Target analytes are bound to magnetic particles. The magnetic particles are pulled down over a magnet. The magnet can be either a permanent magnet, in which case the sample is moved over the magnet, or an electromagnet, where the magnet is turned off and on as needed. An advantage of purification methods involving the binding of nucleic acid to a solid surface is the ability to wash the bound material using solutions that retain the bound molecules on the solid surface while removing other non-related components, thus resulting in isolation and purification of the polynucleotides of interest from the sample solution, After the particles are collected, they may be washed to remove residual material. During the wash steps, the particles may be resuspended in the wash buffer. After washing, the analyte is eluted from the particles. This process provides the added capability to pull down target analytes from a larger sample and to elute in a small volume. Glass-coated magnetically responsive particles have also been developed for nucleic acid isolation. Such particles bind directly or indirectly to nucleic acids. An example of a system that utilizes direct binding includes magnetically responsive porous glass beads (e.g., U.S. Pat. Nos. 4,233,169; 4,395,271; 4,297,337).

A common purification technique uses filters to remove particles above a certain size. In addition, some filters can selectively bind an analyte. Filter material can be welded to the plastic surrounding the opening to a port. The sample can be passed through a filter under certain binding conditions, the filter washed and then the analyte eluted from the filter. Alternatively, analytes can be purified using column chromatography. Filters and/or columns may be incorporated into the fluidics of the disposable cartridge.

Columns may be used to remove contaminants that may interfere with later steps. In particular, enzymatic steps are subject to inhibition by a variety of compounds. In one embodiment, a size exclusion column can be used to remove small molecule inhibitors. Small molecules are caught in pores in the matrix while the larger nucleic acids or proteins pass through the column. Such a column could remove 90-95% of the inhibitory compound from the sample. If needed, more than one column may be used to separate based on different techniques or multiple columns may be used in series to further decrease inhibitor concentrations.

U.S. Pat. No. 8,663,918 describes the incorporation of a column containing a matrix, such as a desalting matrix, in a disposable cartridge. In that design, a column matrix is held in a chamber with a fluid opening in the base of the chamber. The fluid is pushed up through the matrix and over a wall, separating it from an adjoining overflow chamber. The matrix is held in a tubular column with seals on the top and bottom. An additional cap is placed on the top of the column which directs the fluid over the side wall and into the adjoining chamber.

Another embodiment of the current invention provides a design for incorporating a column matrix in a cartridge, without the need for additional plastic parts. A channel in the slide or housing having side walls and a roof or floor formed in that part, with two ports located at each end of the channel, the first part fluidically connected to the syringe and the second port fluidically connected to a chamber to collect the fluid after passage through the column. Filter membranes are placed over each port to restrain the column matrix material when it is rehydrated. The chamber has the open side sealed with a plastic seal, preferably a heat seal, to the top of the walls of the chamber. The column matrix can be dried, set in the channel, and then sealed into the cartridge.

In the case of next-generation sequencing using nanopores, the quality of the nucleic acids is important. DNA should be double-stranded. The nucleic acids should contain minimal insoluble material and not be colored or cloudy. Proteins should be removed, potentially with the generous use of proteinase K. It should be protected from DNA-damaging conditions such as intercalating fluorescent dyes or UV radiation. It should not contain chelating agents (e.g., EDTA), divalent metal cations (like Mg2+), denaturants (like guanidinium salts, phenol), or detergents (like SDS, Triton-X100). It should not contain carryover contamination from the starting organism/tissue (e.g., heme, humic acid, chitin, polysaccharides, polyphenols, etc.) The cartridge of the present invention may also incorporate a detection mechanism. Detection and/or quantitation may be carried out using optical or electrical methods. Optical methods are often used with dyes or fluorescent markers incorporated into the target material or in a probe that is hybridized to the target material. Optical testing can be used to verify the quantity and quality of the nucleic acids. Optical detection processes can measure absorbance at one or more wavelengths or fluorescence.

In a preferred embodiment, a flow cell has an optically clear wall to allow for optical sensing of the product. In an alternative embodiment, the flow cell has an electrical sensor as one wall of the cell, where electrical sensors have a connection external to the disposable to make contact electrically with the reader. Electrical detection may be carried out on sensors as in U.S. Pat. No. 7,851,149 to Braun et al.

In some applications, such as agnostic diagnostics for infectious disease, a two-step lysis protocol can be employed. To deplete host cell nucleic acids, lysing conditions that will disrupt host cells but not pathogenic viruses, bacteria and/or parasites are used. One such approach that has been used widely is to treat the sample with a low-strength detergent such as saponin. The nucleic acids from the host cells are then digested with nucleases. The nucleases are inactivated and the nucleic acids are then isolated from the pathogens.

Inactivation of the nucleases is necessary to prevent degradation of the pathogen NA in the next steps. Although many approaches have been used to inactivate nucleases, guanidine treatment is a preferred method and it is compatible with the plastics used in the cartridge. Guanidine is also very effective at breaking open bacteria and viruses in the same treatment step, further streamlining the process (Oberacker et al. PLOS Biol 17(1): e3000107 (2019). Competing systems struggle with eukaryotic pathogens and encapsulated viruses; the guanidine lysis can overcome these issues.

Guanidine is an efficient disrupter of protein folding and is effective at disrupting cells, bacteria, viruses and parasites. After the inactivation of the nucleases, the guanidine must be removed so it does not interfere with later enzymatic steps. The primary cleanup step that can be incorporated in the current cartridge is magnetic bead capture of the target material with washing. The system will bind the treated NA to magnetic particles, which are then collected and washed. Dispersing the pellet during washing using mixing or low-energy sonication will enable effective removal of the denaturant. In the process, nucleic acids are bound to the magnetic particles. The particles are then pulled down over a magnet and a wash buffer is flowed over the magnetic particles. The chamber is then moved over a sonicator and a low level of energy is used to disrupt the pellet of magnetic particles and nucleic acids. The chamber is then moved back over the magnet, the particles pelleted and then washed again. If needed, this process can be repeated. Disrupting and repelleting the magnetic particles allows for contaminants caught in the pellet to be released and washed away. The nucleic acids are then eluted from the magnetic particles using an elution buffer. Further reduction of small molecule inhibitors can be carried out by passing the eluted material through a column matrix, such as a desalting or nucleic acid binding matrix.

The preferred differential lysis approach in an automated cartridge is to use a mild detergent and mixing or low-energy sonication. These disruption approaches provide a simpler process than typical column and centrifuge-based protocols and were demonstrated by the team previously for automated PCR (unpublished data). Mild detergents can lyse host cells without inactivating introduced nucleases, such as DNase and/or RNase; these nucleases can thus be added directly to the lysed sample mixture without the need for an interim clean-up step. (Wu, et al. Respir Res 22, 310 (2021)). Non-denaturing detergents such as Saponin, Triton, Tween, and NP40 at concentrations that disrupt host cells while leaving pathogens largely intact (Quadt, et al. Parasitol Res 119, 4297-4302 (2020)). For more difficult samples, such as solid tissue or mycobacterium samples, we will evaluate sonication alone or in combination with detergents and more durable nucleases. Alternate pathogen enrichment methods are also available, including separation of methylated nucleic acids and CRISPER-based enrichment methods. (Thoendel, et al. Journal of Microbiological Methods, 127:141-145 (2016)). Preferably, the conditions are optimized for the recovery of long NA (greater than 400 base pairs [bp]) for workflows with nanopore sequencers. In a more preferred embodiment, the fragments are more than 2,000 base pairs in length.

Often, to analyze RNA sequences, the RNA is first converted to DNA via reverse transcription. This involves mixing the purified nucleic acids with a reverse transcription mix, including a reverse transcriptase, and incubating the sample and enzyme for a period of time to produce DNA copies of the RNA. However, more recently, Oxford Nanopore has demonstrated the ability to directly sequence RNA using its nanopore technology. A key requirement for handling RNA is to prevent RNA from degradation by RNases. This cartridge design facilitates the protection of RNA by allowing for the use of procedures or chemicals that can inactivate nucleases and then keeping the RNA sealed in the cartridge and protected from external RNase contamination during the remainder of the protocol.

Many protocols use an amplification step, either PCR, reverse transcriptase PCR, or isothermal amplification to improve sensitivity. Applications of nucleic acid amplification methods include the detection of rare cells, pathogens, altered gene expression in malignancy, and the like. Nucleic acid amplification is potentially useful for both qualitative analyses, such as the detection of nucleic acids present in low levels, as well as the quantification of expressed genes. The latter is particularly useful for the assessment of pathogenic sequences as well as for the determination of gene multiplication or deletion associated with malignant cell transformation. A number of methods for the amplification of nucleic acids have been described, e.g., exponential amplification, linked linear amplification, ligation-based amplification, and transcription-based amplification. An example of exponential nucleic acid amplification method is polymerase chain reaction (PCR) which has been disclosed in numerous publications. (see Mullis et al. Cold Spring Harbor Symp. Quant. Biol. 51:263-273 (1986); PCR Cloning Protocols: From Molecular Cloning to Genetic Engineering, Methods in Molecular Biology, White, B. A., ed., vol. 67(1998 ); Mullis EP 201,184; Mullis et al., U.S. Pat. Nos. 4,582,788 and 4,683,195;

Erlich et al., EP 50,424, EP 84,796, EP 258,017, EP 237,362; and Saiki R. et al., U.S. Pat. No. 4,683,194). Linked linear amplification is disclosed by Wallace et al. in U.S. Pat. No. 6,027,923. Examples of ligation-based amplification are the ligation amplification reaction (LAR), disclosed by Wu et al. in Genomics 4:560 (1989) and the ligase chain reaction, disclosed in EP Application No. 0320308 B 1. Hampson et al. (Nucl. Acids Res. 24(23): 4832-4835, 1996) describe a directional random oligonucleotide primed (DROP) method for use as part of global PCR amplification.

In a typical PCR reaction, template DNA sequences lying between the ends of two defined oligonucleotide primers can be amplified in 1 to 2 hours. Three sequential steps are normally employed: (1) double-stranded DNA is denatured (D) to a single-stranded form at a high temperature (90 °C to 95 °C.), (ii) the resulting single-stranded DNA strands are annealed (A) to oligonucleotide primers at ^{~}40 °C. to 60 ° C., and (iii) primer-template complexes are elongated (E) using a thermostable DNA polymerase such as Thermus aquaticus (Taq) Polymerase at ^{~}72 °C.

One cycle of these three steps (denaturation/annealing/elongation) results in a two-fold amplification of a DNA fragment whose 5′ and 3′ ends are defined by sequence-specific annealing of the oligonucleotide primers to the DNA template. Therefore, 30 PCR cycles result in a 2.30-fold (106-fold) amplification of a particular DNA sequence.

Isothermal target amplification methods include transcription-based amplification methods, in which an RNA polymerase promoter sequence is incorporated into primer extension products at an early stage of the amplification (WO 89/01050), and a target sequence or its complement is amplified by transcription and digestion of the RNA strand in a DNA/RNA hybrid intermediate. (See, for example, U.S. Pat. Nos. 5,169,766 and 4,786,600).

These methods include transcription-mediated amplification (TMA), self-sustained sequence replication (3SR), Nucleic Acid Sequence Based Amplification (NASBA), and variations thereof. (See Guatelli et al. Proc. Natl. Acad. Sci. U.S.A. 87:1874-1878 (1990); U.S. Pat. No. 5,766,849 (TMA); and U.S. Pat. No. 5,654,142 (NASBA)).

Other approaches exist which can also be incorporated into a disposable cartridge. For example, MICROBEnrich employs hybridization capture technology to remove human, mouse, and rat RNA (both mRNA and rRNA) from complex host-bacterial RNA populations, leaving behind enriched microbial total RNA. In the first step of the MICROBEnrich procedure, host-bacterial total RNA is incubated with an optimized mixture of capture oligonucleotides that bind to the mammalian 18S and 28S rRNAs and polyadenylated RNAs. Next, the rRNA/oligo nucleotide hybrids and all polyadenylated mRNAs are removed from the mixture with oligonucleotide-derivatized magnetic beads. After magnetic separation, the bacterial RNA remains in the supernatant and can be precipitated with ethanol.

DNA sequencing technology is rapidly evolving. Next Generation Sequencing (NGS) technologies have greatly improved DNA sequencing capacity, speed and lowered costs dramatically. The current invention can automate the multiple steps of sample handling and library preparation needed before nucleic acid sequencing. Illumina is the leading sequencing technology company utilizing a sequencing by synthesis approach. However, many different technologies are in the market or in development. The current invention can run a wide variety of sample and library preparation protocols tailored for any of these technologies.

The preferred sequencing technology to combine with the current invention is nanopore sequencing. Nanopore sequencers are smaller, easier to use, and lower cost than the alternatives. Combining nanopore sequencing with the current invention provides an end-to-end solution that is fully, automated, low-cost, and easy to use. In a preferred embodiment of the invention, a nanopore sequencing flow cell is built into the cartridge to provide a complete sequencing solution.

After amplification, the nucleic acid library must be prepared for sequencing. This entails several steps, including end preparation and nick repair, ligation of adapters, and a determination of the concentration of the product. Numerous processes and kits are available for library preparation, they can be optimized for output to increase sensitivity, speed for rapid processing, increasing the yield of long nucleic acids for ultra-long reads, processing samples with ultra-low inputs and targeted sequencing. Nanopore sequencing also requires the attachment of a protein to facilitate feeding the strand through the pore. The current cartridge can automate many of the library preparation protocols. The number of reagent reservoirs, reaction chambers, and clean-up steps needed will define the layout of the cartridge.

The cartridge of the current invention can also incorporate a chamber for optical measurements. The optical chamber can be in the shuttle or in the housing.

Preferentially, the optical chamber would be in the housing. Optical measurements can be made of many analytes, including nucleic acids, proteins, cells, viruses, or chemical compounds.

Optical sensing can be colorimetric, including the use of dyes, a measurement of transmission or absorption, detection of particles in solution or analytes bound to a surface, or other optical measuring techniques. As an example, before sequencing, it may be desired to quantitate the nucleic product to load a known amount of material into the sequencing system. Based on the concentration, a buffer may be added to the sample to achieve the target concentration.

Alternatively, an optical signal is quantitated during qPCR. In that case, the optical chamber may also be a chamber for one or more steps of thermocycling. The resulting signal is quantitated and used to calculate the nucleic acid concentration.

The cartridge design is adaptable so that workflows will produce optimized NA products for both short-and long-read sequencing. The cartridge can incorporate unique reagents and steps such as adenylation or linker attachment, or targeted amplification of classes of NA. It can also include barcoding reagents for sequencing multiple samples thus decreasing costs and increasing throughput.

A key concern with nanopore sequencing is accuracy. Barcoding technology can be used to increase accuracy. (Karst, S. M., Ziels, R. M., Kirkegaard, R. H. et al. High-accuracy long-read amplicon sequences using unique molecular identifiers with Nanopore or PacBio sequencing. Nat Methods 18, 165-169 (2021). https://doi.org/10.1038/841592-020-01041). This approach could be automated into the disposable of the current invention, greatly improving the accuracy of a nanopore sequencer with barcoding.

Barcoding can also be used to lower sequencing costs. If a barcoding step is carried out in a cartridge and multiple cartridges have unique barcodes incorporated in the reaction mixtures, products from multiple cartridges can be pooled and run on a single sequencing reaction. The sequences can be sorted via the barcodes. This allows multiple sequences to be run on the same sequencing run, lowering sequencing costs.

Agnostic diagnostic (one that detects any pathogen) capability can be a powerful tool to help real-time public health response. Next-generation sequencing (NGS) technologies can identify any pathogen present in a sample, including novel pathogens. This invention provides a process for nucleic acid preparation for nanopore sequencing, including pathogen enrichment and sample preparation. The process has been developed to be able to run on an automated system. In one approach, the process can be run on a robotic mico-titer plate system for high to moderate throughput. Alternatively, the process can be integrated into a single disposable cartridge which automates and standardizes all steps of the process. It is also able to be combined with library preparation in high or single-throughput automated systems.

The key advantages of this approach are the following capabilities:
Lowering the sample-to-result time to under 24 hours
Reducing interference from host RNA and DNA
Minimizing the need for ancillary equipment and training

The resulting material from this process can be used for diagnostics or nucleic acid sequencing. With variations of the library preparation process, the resulting nucleic acids can be run on a wide variety of sequencing systems, including traditional processes such as Maxim-Gilbert and high-throughput sequencing, which includes next-generation “short-read” and third-generation “long-read” sequencing methods. Sequencing applications include exome sequencing, genome sequencing, genome resequencing, transcriptome profiling (RNA-Seq), DNA-protein interactions (ChIP-sequencing), and epigenome characterization. Nanopore sequencing provides a unique advantage for point-of-care sequencing since it can be carried out in a low-cost portable unit, such as the Oxford Nanopore Minion.

As a first step, pathogen nucleic acids can be enriched relative to the host genetic material. Otherwise, the sequencing system will be overwhelmed with nucleic acids from the host preventing the collection of pathogen sequence information. Multiple processes are utilized in the lab to enrich pathogen materials. Several of these are capable of being incorporated into the current cartridge solution.

One method to enrich pathogen nucleic acids is to selectively lyse host cells, degrade the host nucleic acids, inactivate the nucleases, and then lyse the pathogens and purify their nucleic acids. Such methods can increase the relative concentration of pathogen nucleic acids by 100-1,000 fold.

Lysis of cells/viruses/other pathogens can be carried out via a variety of methods or combinations thereof, including heating, enzymatic treatment, chemical treatment, or mechanical disruption. Host cells, eukaryotic cells, are often easier to break open than bacteria, viruses, spores, and other pathogens. Preferably, the conditions used to lyse host cells or other sample cells will differentially break open those cells while leaving most pathogens intact. Previous studies have shown the effectiveness of differential lysis of host cells.

A preferred approach for differential lysis in an automated cartridge would use a mild detergent and limited physical disruption via mixing or low-energy sonication. Such an approach provides for a simpler overall process flow. Nucleases can be added directly to the lysed sample mixture without the need for an interim clean-up step. Under mild detergent conditions, host cells can be lysed, but introduced nucleases will remain active. Some nucleases are also more resistant to inhibition by detergents and may be preferred. Saponin-based differential lysis procedures have been used to selectively reduce host nucleic acid concentrations. Wu, N., Ranjan, P., Tao, C. et al. Rapid identification of pathogens associated with ventilator-associated pneumonia by Nanopore sequencing. Respir Res 22, 310 (2021).

Other detergents can be used at concentrations to disrupt host cells while leaving pathogens largely intact, such as Triton, Tween, and NP40. Zwitterionic detergents also are preferred.

Denaturing detergents may also be used at lower concentrations. At higher concentrations, denaturing detergents can disrupt pathogens, so the concentration of denaturing detergents should be kept low.

Once host cells are lysed, added nucleases, DNAase, and/or RNAase can be added to preferentially digest the available nucleic acids from the lysed host cells. Pathogenic nucleic acids will be protected since the pathogens largely remain intact. If the lysis treatment for the host cells results in a product that inhibits or inactivates the nucleases, then the sample will need to be cleaned before nuclease treatment.

After lysing the released nucleic acids, the sample needs to be treated to inactivate the nucleases to prevent degradation of the pathogen nucleic acids in the next steps. Multiple approaches have been used to inactive nucleases, including chemical treatment, heating, and enzymatic treatment. The preferred approach is to use a concentrated Guanidine solution. Guanidine treatment has long been a preferred method for nuclease inactivation. Other chemical treatments include the use of chloroform and/or phenol. This approach is very efficient but puts additional requirements on the materials used to assemble the cartridge. Guanidine also is very effective at breaking open bacteria and viruses in the same treatment step, further streamlining the process.

An alternative approach to inactivate nucleases is to treat the mixture with EDTA.

After chemical inactivation of the nucleases, it is essential to efficiently remove the chemical agent or it will interfere with later enzymatic steps in library preparation and sequencing. To remove guanidine or another inactivating agent, the treated nucleic acids can be bound to magnetic particles, collected, and washed. Dispersing the pellet during washing, either using mixing or low-energy sonication will enable the most effective removal of the chemical denaturant. After magnetic clean up, the sample can be passed over a desalting column to further reduce the level of denaturant and other small molecule enzyme inhibitors from the sample. Magnetic clean-up has the advantage over precipitation and centrifugation since it is more easily incorporated into an automated workflow.

The current invention provides a method for selectively removing non-pathogen cells from a sample, wherein the sample is treated with one or more cell disruption techniques at a level sufficient to disrupt the non-pathogen cells in the sample while leaving most of the pathogens intact, introducing one or more nucleases into the treated sample and incubating the mixture to allow the nucleases to degrade nucleic acids released from the disrupted cells, adding a chaotropic salt at a final concentration greater than 0.5 molar, adding magnetic particles to the sample and binding nucleic acids from the pathogens to the magnetic particles, collecting the magnetic particles and bound nucleic acids with a magnet, washing the particles and bound nucleic acids with a wash buffer that maintains the binding of the magnetic particles and the nucleic acids and eluting the nucleic acids from the magnetic particles.

The preferred disruption technique is to treat the sample with a low-strength detergent, in a preferred embodiment of the invention, the detergent is saponin. The sample may be treated with mild detergents and/or low-level to disrupt the non-pathogen cells. During the process, the mild detergent is removed from the sample prior to adding the nucleases. Nucleases can be RNases, DNases, or a combination of RNase and DNase. In a preferred embodiment, the chaotropic salt is a Guanidine salt, preferably at a final concentration greater than one molar and more preferred at a final concentration greater than two molar. If needed, the method further comprises passing the eluted nucleic acids over a desalting column to remove any remaining inhibitors. In addition, the method may also further comprise non-specifically amplifying the nucleic acids eluted from the magnetic particles.

Pathogens may be in low concentrations in a sample. After sample processing, the copy number of the target nucleic acids may be low. Amplification can be used to increase the sensitivity of the overall diagnostic process. Methods for amplification have been discussed above. “Sequence-independent single primer amplification” (SISPA) is a method based on nonspecific amplification using random primers and represents a universally applicable and already proven approach for NGS. This approach is preferred because it maintains an agnostic approach to pathogen detection. SISPA was first developed by Reyes and Kim (Reyes G R, Kim J P. Sequence-independent, single-primer amplification (SISPA) of complex DNA populations. Mol Cell Probes. 1991 Dec; 5(6):473-81). It provides the capability to amplify nucleic acids non-specifically and thus maintain an agnostic diagnostic capability. This could improve sensitivity in agnostic diagnostics by increasing nucleic acid strands for sequencing without needing to target specific sequences. The first step is reverse transcription, where random hexamers labeled with a known specific sequence are directly incorporated into the cDNA. After denaturation, annealing, and double-strain synthesis (Klenow reaction), the yielded dsDNA is amplified using the second SISPA primer consisting of the corresponding known specific sequence without the random hexamers. Hence, it allows the enrichment of the viral genome without the need for virus-specific primers (Schulz A, Sadeghi B, Stoek F, King J, Fischer K, Pohlmann A, Eiden M, Groschup M H. Whole-Genome Sequencing of Six Neglected Arboviruses Circulating in Africa Using Sequence-Independent Single Primer Amplification (SISPA) and MinION Nanopore Technologies. Pathogens. 2022; 11(12): 1502.)

The current invention provides a method for agnostic diagnostic identification of pathogens in a sample comprising, disrupting the pathogens in a sample, isolating and concentrating the nucleic acids, preparing a sequencing library with the nucleic acids, sequencing the nucleic acid library, and analyzing the resulting sequence data for nucleic acid sequences indicating the presence of a pathogen, wherein all steps prior to sequencing are carried out in a single disposable cartridge. Additionally, the number of sequencing reads corresponding to a particular pathogen can be used to determine the amount of pathogen in a sample. In a preferred embodiment of the invention, the sample would be treated initially to disrupt host cells in the sample, and the released nucleic acids would be degraded. In an alternative embodiment, the host cell nucleic acids would be preferentially removed from the sample after disruption of pathogens in the sample before preparing the sequencing library.

The current invention also provides a method for agnostic diagnostic identification of pathogens in a sample comprising preferentially disrupting host cells, digesting host cell nucleic acids, disrupting the pathogens in a sample, and inactivating the nucleases in the sample using a high concentration of a chaotropic salt, isolating and concentrating the nucleic acids, preparing a sequencing library with the nucleic acids, sequencing the nucleic acid library, and analyzing the resulting sequence data for nucleic acid sequences indicating the presence of a pathogen.

In each of these methods, the isolated nucleic acids can be amplified prior to or during the library preparation. In a preferred approach, the amplification of the pathogen nucleic acids would be carried out using an agnostic amplification process.

In addition to nucleic acids, the cartridge of the current invention may also be configured to isolate, process, and prepare for analysis of a wide variety of analytes. A preferred analyte for analysis is proteins. Proteins may be extracted from complex biological samples. This may require disruption of tissue, cells, pathogens, etc., as well as isolation and purification of proteins. In a preferred embodiment, isolation of target proteins can be carried out using antibodies specific to target proteins. Antibodies may be incorporated onto a filter, on beads (especially magnetic beads) or in a column matrix for use in isolation.

During shipping and handling, the cartridge movement may disrupt an unrestrained dry reagent pellet. If part of the dried material is in an area where the liquid cannot dissolve the material, the final concentration of reagents may not be sufficient to run the intended reaction efficiently. Therefore, a preferred embodiment contains the dried materials in a volume so that the dried material (1) does not move around and break apart and (2) is confined to the bottom of the chamber so that when water is introduced into the chamber the entire particle is dissolved.

A method for restraining dried reagent pellets in a cartridge so that they do not move during shipment and handling has been disclosed previously, e.g. U.S. Pat. Nos. 9,057,674, 8,758,701, and 8,187,557. That patent specifically discloses placing a restraining component above the bead in a chamber. However, this approach introduces an additional component, i.e the restraining material which needs to be introduced into the chambers containing the dried materials. This increases the cost by increasing the number of components in the disposable and the handling steps in assembly.

In one embodiment, the current invention provides a design that allows for a chamber built to provide the needed restraint without the introduction of a separate component. In a cartridge, an injection molded housing or shuttle can have chambers consisting of a floor or ceiling and side walls. The open side of the chamber can be sealed with a film that is heat-sealed, welded, or adhered to the cartridge component. The height of the chamber is such that the film restrains the pellet in the channel. An indentation, which is shaped to hold the pellet, can also be made in the ceiling or floor to hold the pellet more specifically. Fluid can be introduced into the cartridge either via a port on a side wall or through a port on the floor or ceiling. The fluidic channel is in fluidic communication with a port on the other surface of the shuttle or housing that can be fluidically connected with the housing or shuttle.

In the current invention, the column matrix chamber preferentially would be in the base of the shuttle or housing. The chamber would be molded with a top wall and side walls. The floor of the injection molded chamber would be open and the chamber would be sealed with a film. Two ports would be located in the top wall at each end of the chamber. A filter material can be welded to the port opening to hold the dried reagent within the channel. Two ports would allow the fluid used to rehydrate the particle to move into the chamber. The first port or opening would be fluidically connected to a syringe via a pathway to allow for fluid to be pushed into the chamber. The second port or opening would allow for air to be vented out of the chamber to prevent back pressure while filling. The second port would be fluidically connected to a separate chamber to collect the solution after passing through the matrix. The solution could then be mixed with further chemistries in that chamber and/or removed by the syringe from that chamber to be used in follow-up steps. In a preferred embodiment, the component would be the shuttle. The ceiling of the chamber would restrain the dried reagent between the ceiling of the chamber and the seal on the bottom of the chamber. Filters can be welded to the ports to restrain the matrix material in the chamber after rehydration.

In production, the shuttle or housing is placed with the chamber opening upwards and the dried materials are placed in each of the chambers. After filling the chambers, the housing would be sealed with a film over the bottom of the component. Filling and sealing of the bottom should be carried out in a dry environment to preserve the activity of the dried reagents.

The preferred system would be optionally powered by battery, small in size, and light in weight, thus permitting complete portable use at any location where patients may be, away from hospitals, laboratories, or even drug stores. The reader is capable of performing fully automated assays (optionally for detecting multiple analytes at the same time) and rapidly obtaining accurate results (typically within 1 or 2 hours and as fast as 15-20 minutes). It is easy to operate, using one or more pre-manufactured test cartridges one can quickly obtain test results,

This newly designed assay system also includes components that provide secure cloud-based connectivity for conveying the diagnostic results from the portable testing device to a remote reporting system, which may be a centralized data collection or processing center or mobile devices such as hand-held devices used by a physician or a patient to receive a diagnostic report. With such cloud-supported connectivity, data sharing can take place virtually instantaneously, not only allowing physicians to start treating patients without any delay but also enabling monitoring and reporting.

These important features circumvent the current limitations that tend to prevent or hinder early testing in poor, remote areas where laboratory facilities are few and testing capability is scarce. The combination of its deployment ability, its rapid and accurate diagnostic functionality, its technical sophistication yet case of operation, and its cloud-based connectivity makes this new assay system the ultimate solution for emerging markets.

The reader may include a barcode reader or an RFID reader. Cartridges may be labeled with a label with either a barcode or RFID tag to allow for tracking of the disposable through manufacturing and storage and for linking the cartridge and sample information. In addition, the system may have the capability to read either barcodes or RFID tags on samples that are analyzed in the system.

A preferred use for the present invention is to automate diagnostics. This includes all forms of biological diagnostics, including testing for chemical analytes, protein chemistry, including immunochemistry, and genomic testing, including testing for the presence of specific nucleic acid sequences as well as nucleic acid sequencing. The present invention can automate a wide variety of techniques or procedures to enable complicated diagnostic protocols. Several key techniques are described below, but the current invention can automate many other techniques and is not limited to those described.

One embodiment of the invention is a system to automate polymerase chain reaction diagnostics, wherein the system isolates nucleic acids from a sample, amplifies target nucleic acids using PCR (if needed a reverse transcription step is also automated), and detects the amplified target or targets. All steps are automated within a single cartridge. Sample preparation and amplification can be automated using some of the chambers needed for NGS preparation. Detection can be carried out optically in the optical flow cell. An array of capture probes can be patterned on the internal surface of the chamber to do an array base detection to multiplex detection and eliminate the need for colored indicators. Gold developer can be used to increase the optical density for improved sensitivity using the process disclosed in U.S. Pat. No. 7,851,149 to Braun et al. In Braun, a gold nanoparticle is attached to the PCR product which is bound to a capture probe on the surface of the array. A gold developer is used to grow gold metal around the nano-particle to give a stronger signal. Primers may also be used with binding regions in the primer such that the gold nan-particle targets a segment of the primer rather than the specific sequence in the target, thus allowing a common sequence to be used to target the PCR products.

Another aspect of the current invention is a cartridge and method for inactivating potentially pathogenic agents in the cartridge at the completion of the assay. Guanidine, or other denaturing solution, is used to disrupt the sample and will inactivate viruses, bacteria, and other pathogens. To render the cartridge inert, the system can be programmed to collect the guanidine waste left over from the disruption step, or alternatively, remaining unused guanidine or other disinfecting reagent stored in a separate chamber in the cartridge and to introduce the denaturing or disinfecting reagent into all channels and chambers that were exposed to the sample to inactivate pathogens from the sample in those channels or chambers. The denaturing reagent can be introduced into each chamber and mixed by moving the syringe back and forth. Additionally, the user can shake or invert the cartridge to ensure that the denaturing reagent coats the top surfaces of all chambers. This feature is beneficial for use in the field or in resource-limited settings where autoclaves may not be available for treating the waste cartridges.

The invention provides a method for inactivating pathogens in the cartridge wherein denaturing solution is moved into each chamber or channel that has had contact with the sample before the sample was inactivated with the denaturing solution.

A key feature of the present invention is the flexibility to run a wide variety of processes. When running a process, some of the reagent chambers, reaction chambers, and process capabilities may not be used. Preferentially, the cartridge would be engineered with sufficient reagent chambers, reaction chambers, syringes and other components to allow for a wide variety of processes to be run in the cartridge. The order of steps may also be changed via the system programming. For a particular process which generates sufficient demand, specific cartridge components that would be made at high volume can be designed.

While the invention has been described with reference to particular embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the scope of the invention.

Therefore, it is intended that the invention is not limited to the particular embodiments disclosed as the best mode contemplated for carrying out this invention but that the invention will include all embodiments falling within the scope and spirit of the appended claims.

The references cited herein provide additional details and are hereby incorporated by reference.

### EXAMPLES

### Example 1: Sample Preparation and Library Preparation for Nanopore Sequencing

Nanopore sequencing is well suited for dispersed nucleic acid sequencing due to the minimal equipment requirements and low costs. Sample preparation is a multi-step process to isolate and clean the nucleic acids for sequencing.

### Sample Lysis and Nucleic Acid Extraction

1. Inject the sample into the sample chamber in the cartridge (250 ul)
2. Add lysis buffer to sample and mix (250 ul 6M Guanidine HCl/SDS)
3. Disrupt sample with low energy sonication
4. Add magnetic beads (200 microliters)
5. Incubate for 5 min at room temperature
6. Collect beads on a magnet
7. Remove liquid and wash magnetic beads with 80% ethanol
8. Disrupt beads with sonication and rinse again
9. Push air over the pellet to remove the remaining ethanol
10. Add 24 microliters of resuspension buffer and mix
11. Pull down magnetic beads with a magnet
12. Remove 20 microliters of supernatant
13. Load supernatant on the desalting matrix
14. Use air or buffer to push the sample through the column
15. Collect elute

### Example 2: Amplification of nucleic acids

Many protocols use an amplification step, either PCR, reverse transcriptase PCR, or isothermal amplification to improve sensitivity. When targeting RNA, the RNA first needs to be converted to DNA.

### Reverse Transcription PCR:

1. Mix isolated nucleic acids with reverse transcription buffer and reverse transcriptase.
2. Incubate at 50 C for 20 min
3. Add in PCR mix and incubate the reaction as follows:
   25 °C for 2 min
   55 °C for 10 min
   95 °C for 1 min
      Alternatively, isothermal amplification can be utilized:

### Isothermal Amplification:

1. Rehydrate isothermal amplification mix
2. Hold the mix for 10 min at 20 C
3. Mix the sample with the amplification mix
4. Incubate reaction at 42 C for 25 min

### Example 3: Library Preparation

After amplification, the nucleic acid library must be prepared for sequencing. This entails several steps, including end preparation and nick repair, ligation of adapters, and a determination of the concentration of the product.
End Prep and Nick Repair
   Rehydrate nick repair mix
   Mix with sample
   Incubate at 37 C for 20 min
Ligation of adapters
   Rehydrate ligation mix
   Mix with sample
   Incubate at 37 C for 20 min

Before sequencing, it may be desired to quantitate the nucleic product to load a known amount of material into the sequencing system. This can be carried out by mixing a portion of the nucleic acids with a dye or other indicator molecule that interacts with the nucleic acids and produces a signal proportional to the amount of nucleic acids in the solution. The nucleic acid solution with an indicator can be visualized in an optical chamber in the cartridge, preferably in the housing, which has one or more optically transmissive walls.

Alternatively, quantitative PCR can be used to measure the amount of nucleic acids present. A representative reaction is prepared by:

Mix 2 ul of the prepared nucleotides with adapters with 20 ul of qPCR mix qPCR is carried with a heat Cycle as follows:
98 C for 30 sec
64 C for 15 sec
72 C for 30 sec

An optical signal is quantitated during qPCR. The resulting signal is quantitated and used to calculate the nucleic acid concentration. Based on the concentration, a buffer may be added to the sample to achieve the target concentration.

### Example 4: Host Cell Depletion From Clinical Samples

In summary, a preferred protocol for preparing pathogen nucleic acids from a complex sample is as follows:
1. Treat samples with mild detergents and/or low-level sonication sufficient to break open host cells.
2. Mix in nucleases (RNase and DNase) and incubate. Preferably utilize nucleases that remain active in the differential lysis buffer. (If needed, the nucleic acids can be captured, rinsed, and resuspended in a buffer compatible with the nucleases.)
3. Add an equal volume of 4M-6M Guanidine to the sample mixture and incubate the mixture to inactivate the nucleases and disrupt the pathogens.
4. Add para-magnetic beads to the sample mixture with the appropriate buffer to bind nucleic acids.
5. Magnetically capture the nucleic acids on the beads. Then, wash the beads, disrupting the bead pellet during the washes.
6. Elute the nucleic acids from the beads with an elution buffer, disrupting the pellet to suspend it in the elution buffer and collecting the magnetic beads over a magnet before removing the elution buffer with nucleic acids.
7. (Optional) Pass the eluted nucleic acids over a desalting column to remove any remaining inhibitors.

### Example 5: Non-Specific Amplification

1. Convert RNA to DNA with a reverse transcription step
2. Use Klenow enzyme to convert the DNA to a double-stranded form-attach primers for amplification. The primers can also include bar codes
3. PCR amplify the DNA non-specifically by using PCR primers complementary to sequences incorporated into the primers attached in step 2.

### Example 6: Process Flow for Agnostic Diagnostics

The following outlines a possible process flow and layout in the cartridge for agnostic pathogen identification. Approximate volumes for each of the reagents are also provided. The process is divided into four segments: sample preparation, amplification, library preparation, and quantitation.

### Sample Preparation

1. Sample Chamber—Introduce up to 1 ml of sample
   (Need a total capacity of 2.1 ml)
   May go over sonicator or heater (could use sonicator for heat)
   Circular chamber
2. Host Cell lysis buffer—300 ul
   Saponin or other detergent to be added to the sample chamber
3. Dried nuclease mix-dry, 50 ul
   Resuspend with 50 ul of sample mix, add to the sample chamber
4. Guanidine—700 ul
   Add to the Sample chamber
5. Magnetic particles—100 ul
   Add to the sample chamber
   Move the sample mix over a magnet in a magnetic separation chamber in the base
6. Wash buffer—500 ul total
   Push 250 ul of wash over the particles while on a magnet
   Move the chamber over the sonicator and briefly pulse to break apart the pellet
   Move over a magnet to pull down the particles
   Repeat process
   Push air over the pellet
7. Elution buffer—35 ul
   Use the small syringe to fill a magnetic chamber
   Move the chamber over the sonicator and briefly pulse to break apart the pellet
   Move over a magnet and remove the eluted material with the small syringe

### Amplification

8. Reverse transcriptase
   Push eluted material into a chamber with dried enzyme and random hexamers
   Mix by pipetting back and forth
   Move the mix to a reaction chamber in the base and incubate
9. Klenow conversion to DS-DNA
   Move the mix to a chamber with dry Klenow enzyme
   Mix by pipetting back and forth
   Move the mix to a reaction chamber in the base and incubate
10. PCR amplification
   Move the mix to a chamber with dry PCR mix
   Mix by pipetting back and forth
   Move the mix to a reaction chamber in the base and incubate
11. Magnetic bead clean-up
   Add to a magnetic separation chamber with 10 ul of magnetic beads
   Move to a magnetic separation chamber
12. Wash buffer—200 ul total
   Push 100 ul of wash over the particles while on a magnet
   Move the chamber over the sonicator and briefly pulse to break apart the pellet
   Move over a magnet to pull down the particles
   Repeat the process
   Push air over pellet
13. Elution buffer—35 ul
   Use the small syringe to fill a magnetic chamber
   Move the chamber over the sonicator and briefly pulse to break apart the pellet
   Move over a magnet and remove the eluted material

### Library Preparation

14. End-prep
   Add elution buffer to a chamber with dried end prep mix
   Move to magnetic separation chamber in base and incubate
15. Ligation of sequencing adapters
   Add elution buffer to the chamber with dried adapter mix
   Move to a reaction chamber in base and incubate
16. Elution buffer (sequencing buffer)—35 ul
   Use the small syringe to fill the magnetic chamber
   Move the chamber over the sonicator and briefly pulse to break apart the pellet
   Move the chamber over a magnet and remove the eluted material
17. Place material in a top side chamber for removal to a sequencer, the chamber should have a cap or removable seal for access

### Quantitation

18. Mix with indicator dye mix—30ul
   Add 3.5 ul of mix and add to dye reagent
   Move the mix to the optical chamber and measure the DNA concentration Add additional sequencing buffer to adjust the final concentration of DNA to the target range
   The agnostic diagnostic protocol can be modified to allow users to select optional processes on the controller, such as host cell depletion and amplification. The same cartridge can be used; the controller is programmed to skip certain steps.
   There are three magnetic clean-up steps. The first occurs in sample prep and should have separate reagent chambers. The last two are smaller volumes and are in the library preparation phase. Common chambers may be used for the reagents. Since magnetic separation chambers will have used particles when finished, each magnetic separation needs a separate chamber.
   The cartridge will need a waste chamber or chambers with a total volume of at least 3.0 mls. Waste can be placed in empty reagent chambers, as well as a dedicated waste chamber.
   The reverse transcription, Klenow, and PCR steps can use the same reaction chamber.
   The optical chamber could be in the housing base for two-sided access.

1. A disposable cartridge for chemical or biological analysis, comprising:
a housing having a rail with two parallel side walls with one or more fixed ports in one or both of the side walls, and one or more syringe barrels defining a bore in fluid communication with one or more fixed ports, the one or more syringe barrels having a moveable plunger; and
a shuttle having two parallel exterior surfaces that slide along the side walls of the rail of the housing, the shuttle comprising:
a plurality of chambers fluidly connecting to a plurality of ports along the exterior surfaces at different positions; and
wherein sliding the shuttle aligns one of the shuttle ports with a fixed port on the housing such that fluid may be moved into and out of the plurality of chambers in response to displacement of the moveable plunger.

2. The disposable cartridge, according to claim 1, wherein
the housing has two or more syringe barrels having at least two different volumes.

3. The disposable cartridge, according to claim 1, further comprising a lid that interfaces with the top of the shuttle wherein:
the lid has features that hold the unstable reagents in a position that when the lid and the shuttle are connected, holds the unstable reagents in the appropriate chambers at a position the unstable reagents are fluidically connected to a syringe.

4. The disposable cartridge according to claim 1, further comprising reaction chambers in the base of the shuttle wherein:
the reaction chambers consist of side walls and a ceiling formed in the injection molded shuttle and a floor formed by a film attached to the base of the shuttle and
the reaction chambers are fluidically connected through ports and channels to a port on
the side wall of the shuttle that can be aligned with a port in the housing which is fluidically connected to a syringe.

5. The disposable cartridge according to claim 2 wherein, the two or more syringe barrels have different internal volumes.

6. The disposable cartridge according to claim 1, wherein a first of the two or more syringe barrels has an internal volume greater than 100 microliters and a second of the two or more syringe barrels has a volume less than 100 microliters.

7. A disposable cartridge according to claim 1, wherein the disposable cartridge is stored as two or more components to allow storage of non-compatible reagents in separate packaging chambers.

8. The disposable cartridge, according to claim 1, wherein the housing comprises chambers to hold freeze-dried reagents, and one or more of the plurality of chambers in the insert contains liquid reagents.
